(19) United States
(12) Patent Application Publication
(10) Pub. No.: US 2010/0309420 A1
(43) Pub. Date: Dec. 9, 2010

(54) LOW-COST LARGE-SCREEN WIDE-ANGLE FAST-RESPONSE LIQUID CRYSTAL DISPLAY APPARATUS

(75) Inventors: Sakae Tanaka, Mito City (JP); Toshiyuki Samejima, Tokyo (JP)

Correspondence Address: SCHMEISER, OLSEN & WATTS, 22 CENTURY HILL DRIVE, SUITE 302, LATHAM, NY, 12110, US

(73) Assignee: MIKUNI ELECTORON CO. LTD., Ibaraki Prefecture (JP)

(21) Appl. No.: 12/859,319

(22) Filed: Aug. 19, 2010

Related U.S. Application Data
(63) Continuation-in-part of application No. 11/743,749, filed on May 3, 2007.

(30) Foreign Application Priority Data
Jun. 15, 2006 (JP) 2006-202563

(51) Int. Cl. G02F 1/1343

(52) U.S. Cl. 349/143

(57) ABSTRACT

An active matrix vertical alignment liquid crystal display apparatus comprises a transparent pixel electrode formed on a transparent substrate of TFT, and another transparent pixel electrode is connected to a drain electrode of the transparent substrate of TFT. A transparent insulating film is provided on the transparent pixel electrodes; and a plurality of slender slits are provided and have liquid crystal alignment power in the transparent pixel electrode, wherein the liquid crystal alignment control electrodes which are slender formed on the transparent insulating layer, and the liquid crystal alignment control electrode are connected to the transparent pixel electrode, and a transparent common electrode is located on an opposite transparent substrate, which is positioned opposite to the transparent TFT substrate, and the transparent TFT substrate is connected to common electrodes formed on the transparent TFT substrate.

### CROSS-REFERENCE TO RELATED APPLICATION

This application is a continuation-in-part patent application of U.S. application Ser. No. 11/743,749 filed on May 3, 2007, the entire contents of which are hereby incorporated by reference for which priority is claimed under 35 U.S.C. §120. This application claims foreign priority to Japanese Patent Application No. 2006202563, filed Jun. 15, 2006, the entire contents of which are hereby incorporated under U U.S.C. §119.

### FIELD OF THE TECHNOLOGY

The present invention relates to a large-screen wide-angle liquid crystal display apparatus manufactured by using a halftone exposure method.

### BACKGROUND

In multi-domain vertical alignment (MVA) liquid crystal display apparatuses, an alignment control electrode for controlling an alignment of a liquid crystal molecule. has been disclosed in Japan Laid Open Patents Nos. 07-230097, 11-109393 and 2001-042347.

### SUMMARY

In view of the shortcomings of the prior art, the inventor of the present invention based on years of experience in the related industry to conduct researches and experiments, and finally developed a large-screen wide-angle liquid crystal display apparatus in accordance with the present invention to overcome the foregoing shortcomings.

Therefore, it is a primary objective of the present invention to adopt a prior art alignment control electrode of an LCD panel structure to correspond to smaller pixels. Since only one type of alignment control electrode is used only, and the edge field effect of a pixel electrode is adopted, therefore it is not applicable for lager pixels.

At present, the mainstream of multi-domain vertical alignment (MVA) liquid crystal display apparatus generally uses a bump or slit electrode for the alignment control of the sides of a color filter (CF) substrate, and this method can make a proper alignment if the pixel is large, but the cost of CF substrates is high, and becomes an obstacle for manufacturing a large-screen liquid crystal TV by a low cost.

Therefore, it is a primary objective of the present invention to reduce the number of photolithographic procedures of the TFT active matrix substrate and the CF substrate during the manufacture of the TFT active matrix liquid crystal display apparatus, in order to shorten the manufacturing procedure, lowering the manufacturing cost, and improving the yield rate.

The technical measures taken by the present invention are described as follows.

In Measure 1, unstable and swinging discrimination lines are avoided, and two types of alignment control electrodes are installed at an upper layer of a pixel electrode through an insulating film, and between common electrodes corresponding to the pixel electrodes. With the foregoing two different types of alignment control electrodes, the oblique direction of anisotropic liquid crystal molecules having a negative dielectric constant can be controlled precisely.

In Measure 2, one type of alignment control electrode is installed at an upper layer of a pixel electrode through an insulating film, and a slender slit is formed in the pixel electrode, and these two alignment control mechanisms can control the oblique direction of anisotropic liquid crystal molecules having a negative dielectric constant precisely.

In Measure 3, the alignment control electrodes as used in Measures 1 and 2 are connected to the pixel electrodes as closer to the substrate as possible.

In Measure 4, the alignment control mechanisms as used in Measures 1 and 2 provides four perfect area alignments for a curvature of 90 degrees at a position proximate to the center of the pixel.

In Measure 5, a halftone exposure method is introduced into the manufacturing process of the TFT array substrate to reduce the number of photolithographic procedures.

In Measure 6, a basic unit pixel is divided into two sub pixels, and the common electrodes are installed parallelly on a video signal line, and the common electrodes of odd-numbered rows and even-numbered rows switch signals with different polarities in each scan period, and produce different voltages applied to the liquid crystal molecules of the two sub pixels.

With Measures 1 and 2, the TFT array substrate has all alignment control functions, and thus it is not necessary to form a pad or slit on the CF substrate for the alignment control, so that the MVA LCD panel can be manufactured with a low-cost CF substrate to lower the cost and improve the yield rate.

With Measure 3, the alignment control electrode connected to the pixel electrode is proximate to the substrate for enhancing the rotational torque of an electric field of anisotropic liquid crystal molecules having negative dielectric constant and acted at the vertical alignment, so as to achieve a high-speed response.

With Measure 4, unnecessary discrimination lines can be avoided to improve the overall light transmission rate of the screen and reduce unevenness of the LCD panel.

With Measures 1, 2 and 5, the processing costs for both CF substrate and TFT array substrate can be lowered, and thus the manufacturing cost of MVA LCD panels can be lowered significantly; the production efficiency can be improved, and the yield rate can be enhanced.

With Measures 5 and 6, the liquid crystal alignment control mechanism can be manufactured by a very simple manufacturing process, and the correction of γ curve can be achieved by a very simple circuit, and thus a little cost is incurred for enhancing the display quality of a MVA liquid crystal display apparatus.

### BRIEF DESCRIPTION OF THE DRAWINGS

FIG. 1 is a cross-sectional view of a conventional MVA LCD panel;

FIG. 2 is a cross-sectional view of a conventional MVA LCD panel;

FIG. 3 is a cross-sectional view of a MVA LCD panel of the present invention;

FIG. 4 is a cross-sectional view of a MVA LCD panel of the present invention;

FIG. 5 is a schematic view of the principle of a MVA LCD panel of the present invention;

FIG. 6 is a schematic view of the principle of a MVA LCD panel of the present invention;

FIG. 7 is a schematic view of the principle of a MVA LCD panel of the present invention;

FIG. 8 is a cross-sectional view of a MVA LCD panel adopting a TFT matrix substrate in accordance with the present invention;

FIG. 9 is a cross-sectional view of a TFT array substrate used for a MVA LCD panel in accordance with the present invention;

FIG. 10 is a cross-sectional view of a TFT array substrate used for a MVA LCD panel in accordance with the present invention;

FIG. 11 is a cross-sectional view of a TFT array substrate used in a MVA LCD panel in accordance with the present invention;

FIG. 12 is a cross-sectional view of a TFT array substrate used in a MVA LCD panel in accordance with the present invention;

FIG. 13 is a cross-sectional view of a TFT array substrate used in a MVA LCD panel in accordance with the present invention;

FIG. 14 is a cross-sectional view of a TFT array substrate used in a MVA LCD panel in accordance with the present invention;

FIG. 15 is a planar view of a TFT array substrate used in a MVA LCD panel in accordance with the present invention;

FIG. 16 is a planar view of a TFT array substrate used in a MVA LCD panel in accordance with the present invention;

FIG. 17 is a planar view of a TFT array substrate used in a MVA LCD panel in accordance with the present invention;

FIG. 18 is a planar view of a TFT array substrate used in a MVA LCD panel in accordance with the present invention;

FIG. 19 is a planar view of a TFT array substrate used in a MVA LCD panel in accordance with the present invention;

FIG. 20 is a planar view of a TFT array substrate used in a MVA LCD panel in accordance with the present invention;

FIG. 21 is a planar view of a TFT array substrate used in a MVA LCD panel in accordance with the present invention;

FIG. 22 is a planar view of a TFT array substrate used in a MVA LCD panel in accordance with the present invention;

FIG. 23 shows a circuit model of a TFT array substrate of field-sequential driven MVA LCD panel in accordance with the present invention;

FIG. 24 shows a relation between the brightness and the signal voltage applied to a MVA LCD panel as depicted in FIG. 23;

FIG. 25 is a waveform diagram of a MVA LCD panel as depicted in FIG. 14;

FIG. 26 shows a circuit model of a TFT array substrate that is divided into upper and lower field-sequential driven MVA LCD panels in accordance with the present invention;

FIG. 27 illustrates a field-sequential driving method that divides a screen into upper and lower sections and writes data from the center of the screen to the upper or lower section of the screen in accordance with the present invention;

FIG. 28 illustrates a field-sequential driving method that divides a screen into upper and lower sections and writes data from the upper or lower sections of the screen towards the center of the screen in accordance with the present invention;

FIG. 29 illustrates a field-sequential driving method that divides a screen into upper and lower sections and writes data from the center of the screen to the upper or lower section of the screen in accordance with the present invention;

FIG. 30 illustrates a field-sequential driving method that divides a screen into upper and lower sections and writes data from the upper or lower sections of the screen towards the center of the screen in accordance with the present invention;

FIG. 31 is a cross-sectional view of a basic unit pixel of a TFT array substrate of a horizontal electric field LCD panel in accordance with the present invention;

FIG. 32 is a cross-sectional view of a basic unit pixel of a TFT array substrate of a horizontal electric field LCD panel in accordance with the present invention;

FIG. 33 shows a circuit model of a circuit of a TFT array substrate of a field-sequential driven horizontal electric field LCD panel in accordance with the present invention;

FIG. 34 is a cross-sectional view of a TFT array substrate of a horizontal electric field LCD panel in accordance with the present invention;

FIG. 35 is a planar view of a TFT array substrate of a horizontal electric field LCD panel in accordance with the present invention;

FIG. 36 is a planar view of a TFT array substrate of a horizontal electric field LCD panel in accordance with the present invention;

FIG. 37 is a waveform diagram of a horizontal electric field LCD panel as depicted in FIG. 36;

FIG. 38 shows a circuit model of a TFT array substrate of a field-sequential driven horizontal electric field LCD panel that divides a display screen into upper and lower sections in accordance with the present invention;

FIG. 39 is a cross-sectional view of a basic unit pixel of a TFT array substrate of a MVA LCD panel in accordance with the present invention;

FIG. 40 is a cross-sectional view of a basic unit pixel of a TFT array substrate of a MVA LCD panel in accordance with the present invention;

FIG. 41 is a cross-sectional view of a basic unit pixel of a TFT array substrate of a MVA LCD panel in accordance with the present invention;

FIG. 42 is a cross-sectional view of a basic unit pixel of a TFT array substrate of a MVA LCD panel in accordance with the present invention;

FIG. 43 is a cross-sectional view of a manufacturing flow that adopts a halftone exposure method to form a contact pad for a pixel electrode in accordance with the present invention;

FIG. 44 is a cross-sectional view of a manufacturing flow that adopts a halftone exposure method to form a contact pad for a pixel electrode in accordance with the present invention;

FIG. 45 is a cross-sectional view of a manufacturing flow that adopts a halftone exposure method to give an island effect to a semiconductor layer of a thin film transistor component and form a contact hole in accordance with the present invention;

FIG. 46 is a cross-sectional view of a manufacturing flow that forms a source electrode, a drain electrode, a terminal electrode, and comb common electrode in accordance with the present invention;

FIG. 47 is a cross-sectional view of a flow of manufacturing a thin film transistor substrate by a halftone exposure method in accordance with the present invention;

FIG. 48 illustrates the structure of a horizontal electric field active matrix substrate at a center pixel common electrode of the center of a basic unit pixel;

FIG. 49 illustrates a masking principle of a halftone exposure applied in the present invention;

FIG. 50 illustrates the principle of a halftone multiple exposure method applied in the present invention;

FIG. 51 is a cross-sectional view of a manufacturing flow of using a halftone exposure method to form a thin film transistor substrate in accordance with the present invention;

FIG. 52 is a cross-sectional view of a manufacturing flow of using a halftone exposure method to form a scan line portion, a pixel electrode and a terminal portion of a thin film transistor substrate in accordance with the present invention;

FIG. 53 shows a cross-sectional view of a manufacturing flow of using a halftone exposure method to give an island effect to a semiconductor layer of a thin film transistor component and expose a pixel electrode and a terminal portion completely;

FIG. 54 shows a cross-sectional view of a manufacturing flow before forming a source electrode and a drain electrode in the process of manufacturing a thin film transistor component as illustrated in FIGS. 53 and 54;

FIG. 55 is cross-sectional view of the conventional structure forming a TFT array substrate of an alignment control electrode connected to a scan line and disposed on the previously formed pixel electrode;

FIG. 56 is a planar view of a TFT array substrate as depicted in FIG. 55;

FIG. 57 is a cross-sectional view of forming a vertical alignment cell of one type of alignment control electrode connected to a common electrode and disposed on the previously formed pixel electrode;

FIG. 58 is a cross-sectional view of a vertical alignment cell of one type of alignment control electrode connected to a pixel electrode and disposed on the previously formed plate electrode;

FIG. 59 is a cross-sectional view of a conventional structure of forming only one type of alignment control electrode on a pixel electrode of the previously formed TFT array substrate;

FIG. 60 is a cross-sectional view of a conventional structure of forming only one type of alignment control electrode on a pixel electrode of the previously formed TFT array substrate;

FIG. 61 is a cross-sectional view of a conventional structure of forming only one type of alignment control electrode on a pixel electrode of the previously formed TFT array substrate;

FIG. 62 illustrates a manufacturing flow of performing the photolithographic procedure for three times that uses a MVA TFT array substrate to apply a halftone exposure method for two times;

FIG. 63 illustrates a manufacturing flow of performing the photolithographic procedure for three times that uses a MVA TFT array substrate to apply a halftone exposure method for two times;

FIG. 64 illustrates a manufacturing flow of performing the photolithographic procedure for three times that uses an IPS TFT array substrate to apply a halftone exposure method for three times;

FIG. 65 illustrates a manufacturing flow of performing the photolithographic procedure for three times that uses an IPS TFT array substrate to apply a halftone exposure method for three times; and

FIG. 66 illustrate a schematic view of edges of a transparent pixel electrode in relation with a first liquid alignment control electrode and a second liquid alignment control electrode.

### DETAILED DESCRIPTION

To make it easier for our examiner to understand the objective, innovative features and performance of the present invention, we use a preferred embodiment and the accompanying drawings for a detailed description of the present invention.

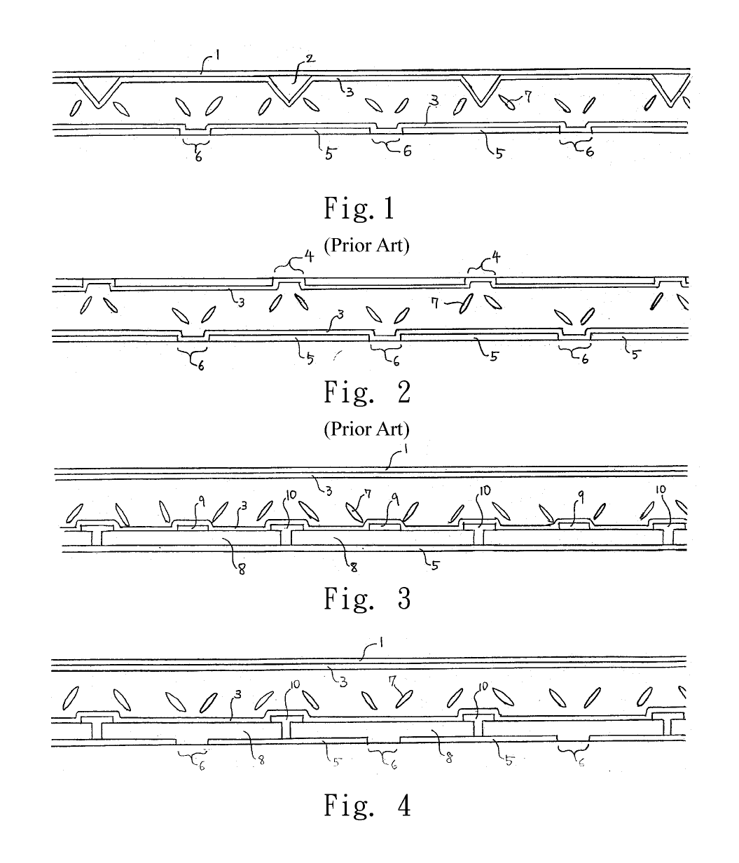

Referring to FIGS. 1 and 2 for cross-sectional views of a current mainstream MVA LCD panel, a mechanism for controlling the direction of movements both is installed separately on upper and lower substrates to control the vertical alignment of anisotropic liquid crystal molecules of a negative dielectric constant. Since the discrimination line position in a pixel using this method is fixed without moving, uniform brightness is displayed in this LCD panel, and high quality LCD panels can be produced as a good yield rate. However, it is necessary to form a slit or a bump disposed on a lateral side of a CF substrate corresponding to a TFT substrate for the structure as shown in FIGS. 1 and 2 to control the liquid crystal alignment, and the production cost of the CF substrate is higher than that of the TN CF substrate. To lower the cost of the CF substrate, all liquid crystal alignment control functions are built in the TFT substrate side.

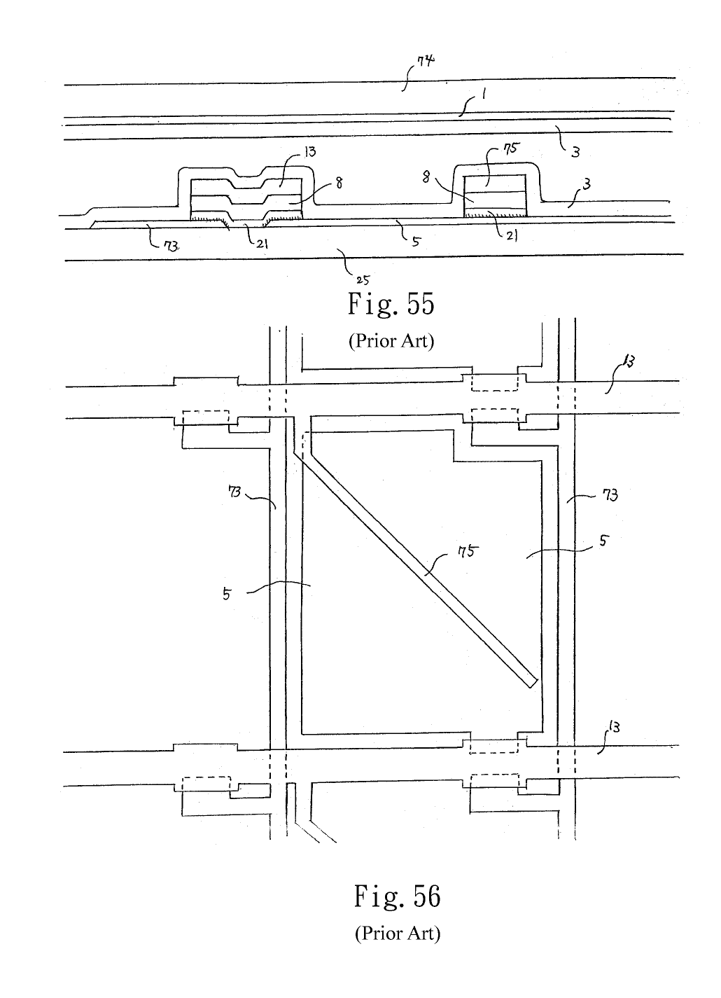

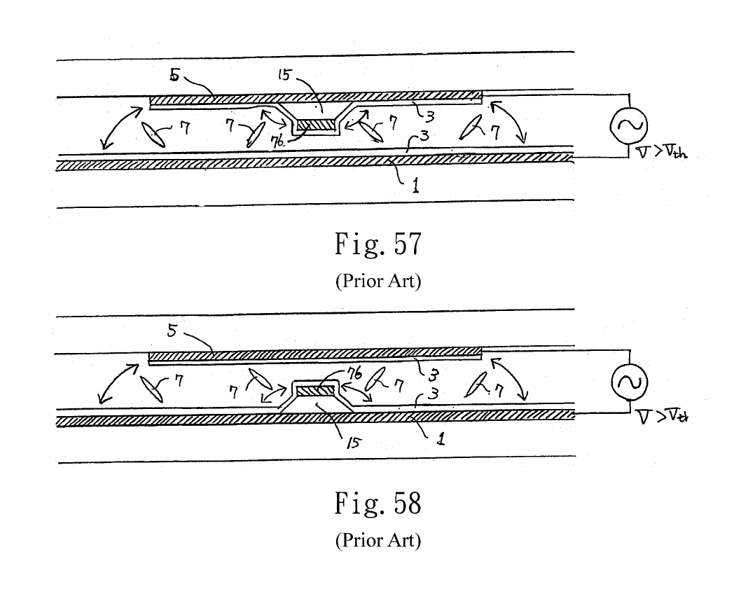

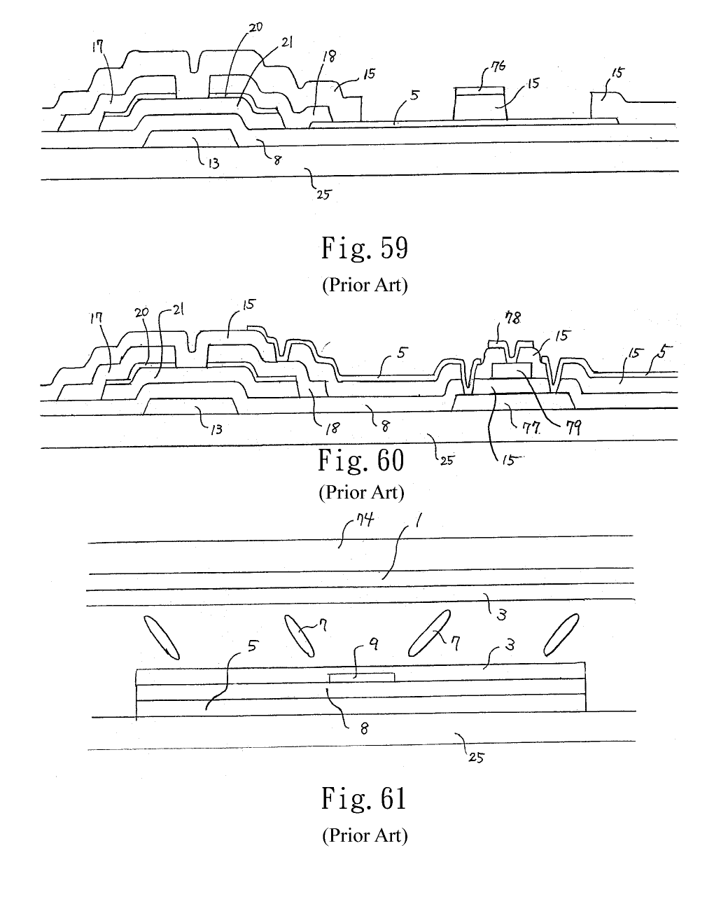

Referring to FIGS. 55 to 61 for an embodiment of a CF substrate side having no alignment control function as disclosed in the previous patents, these CF substrates cannot be used as large substrates. These prior arts can be used for small pixels only. Since an edge field effect of a pixel electrode is used, therefore these substrates are not appropriate for the large pixel electrodes used for the liquid crystal TV.

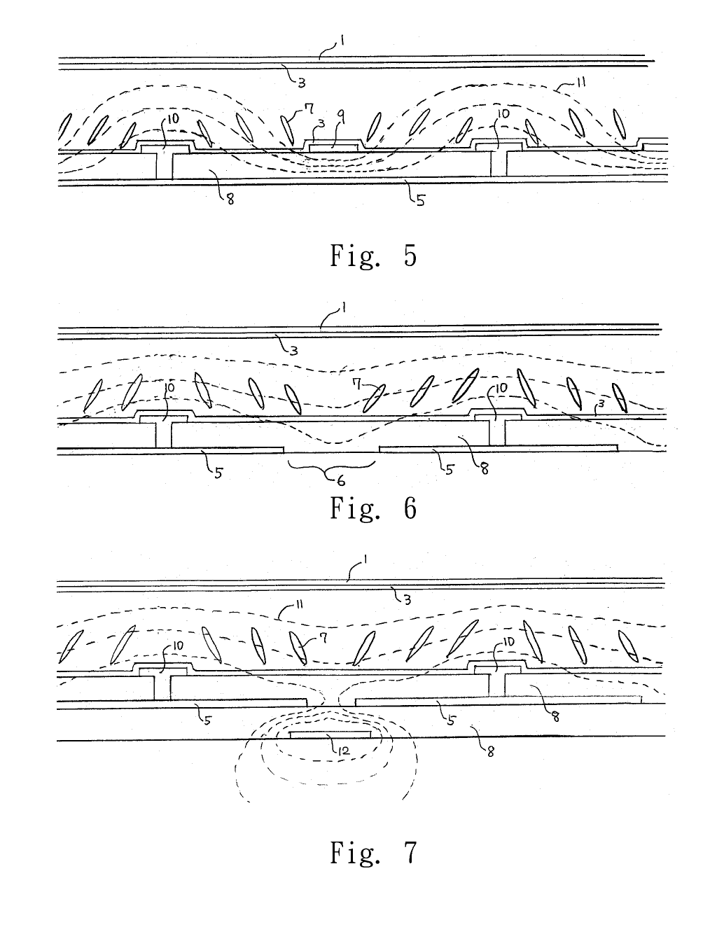

With the two basic structures as shown in FIGS. 3 and 4, a TFT substrate side has all of the liquid crystal alignment control functions. In the TFT substrate side as shown in FIG. 3, two different liquid crystal alignment control electrodes are installed between the common electrode of the substrate and corresponding to the pixel electrode to successfully form an equal-potential distribution as shown in FIG. 5. Alignment control electrode of FIG. 4 is installed on a pixel electrode at the TFT substrate side and between the slit for alignment control and the pixel electrode corresponding to the common electrode of the substrate to successfully from an equal-potential distribution as shown in FIG. 6. Even for a structure as shown in FIG. 7 instead of the structure as shown in FIG. 6, the similar equal-potential distribution an be formed successfully.

A liquid crystal alignment control electrode connected to a pixel electrode is installed at an upper layer of the pixel electrode as shown in FIG. 5. The closer the distance from the common electrode of the CF substrate, the more similar is the equal-potential distribution diagram of the pixel electrode through another type of liquid crystal alignment control electrode formed by an insulating film. Since the liquid crystal alignment control electrode not connected to the pixel electrode yet is connected to a common electrode same potential of the corresponding substrate.

If a cell gap is greater than 5 μm, the structure of a pixel electrode of a TFT substrate connected to the liquid crystal alignment control electrode in accordance with the present invention almost has no effect. However, if the cell gap is below 3 μm, the effect is significant. If the cell gap is below 2.5 μm, a sufficiently equal-potential distribution diagram is formed for controlling the alignment of liquid crystal molecules.

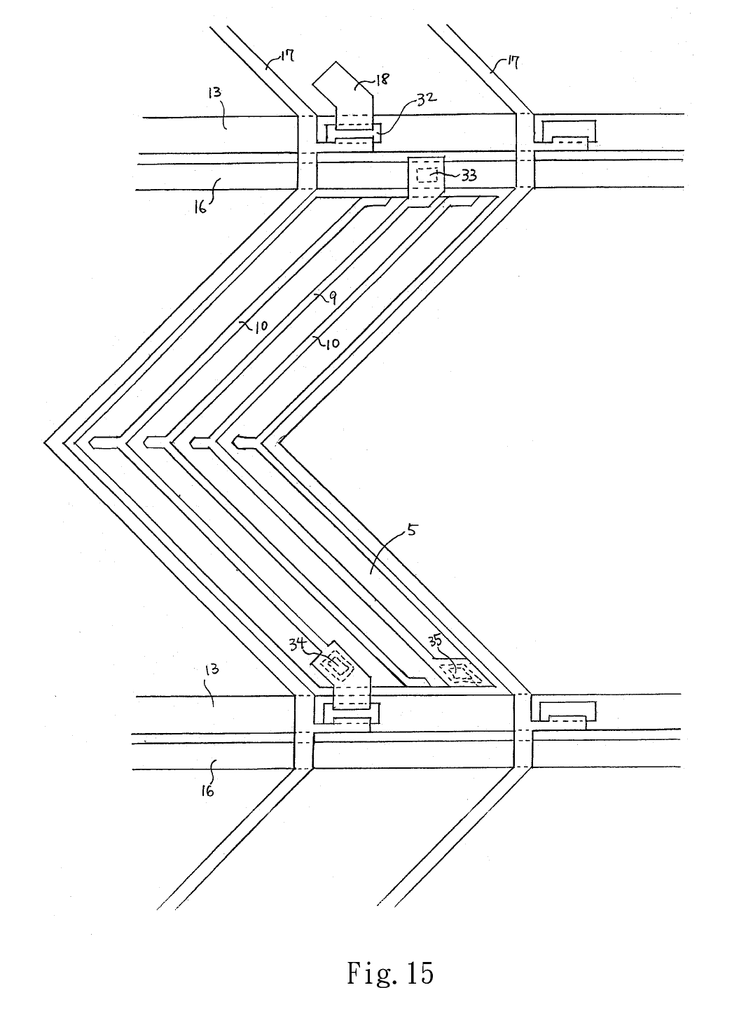

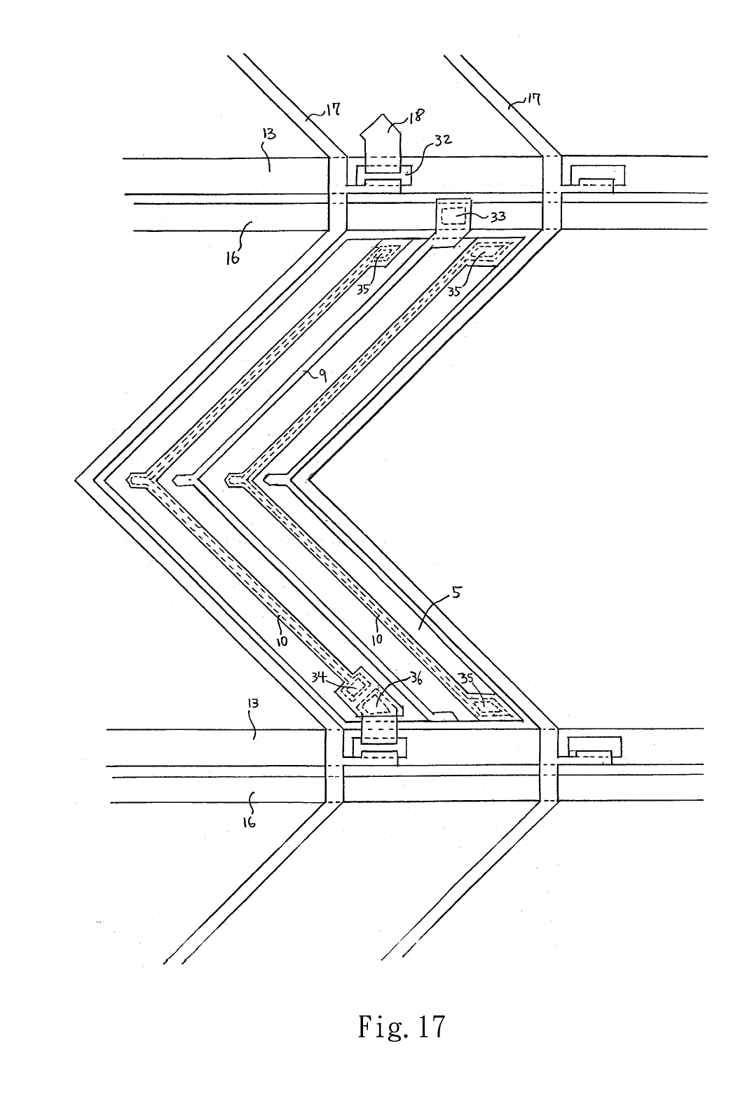

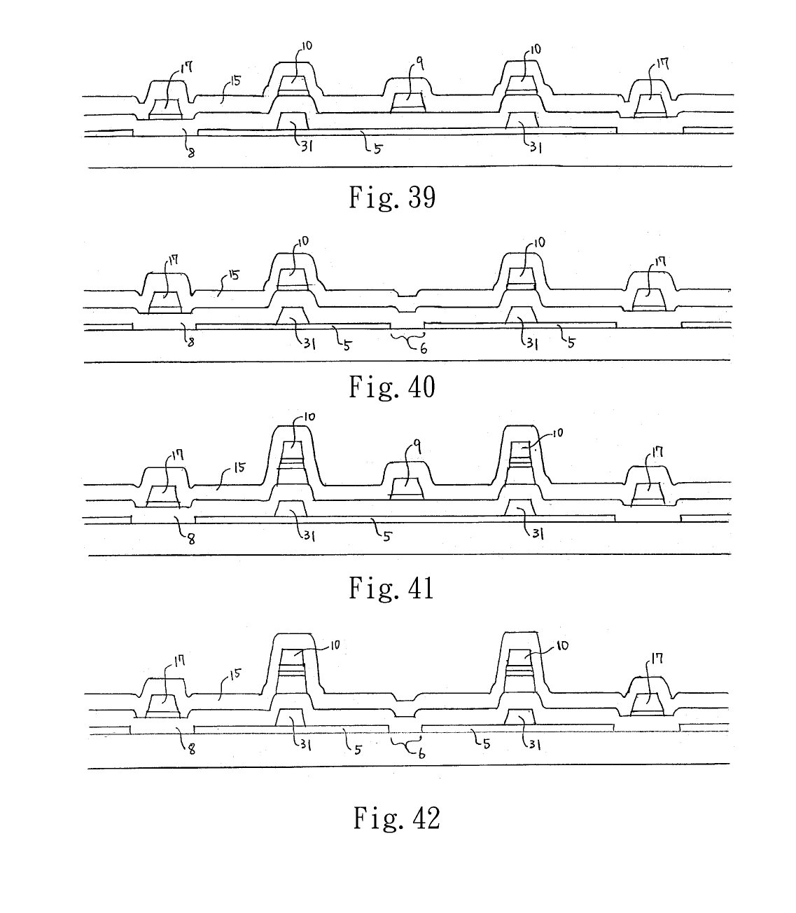

Referring to FIGS. 15 and 17 for planar views of Embodiment 1 of a TFT substrate, two types of different alignment control electrodes are formed at an upper layer of a pixel electrode, and an alignment control electrode installed at the middle of a pixel is coupled to a gate electrode and installed parallel with a common electrode. Another alignment control electrode with a different alignment control is passed and disposed at a contact pad in the pixel electrode and coupled to the pixel electrode. Referring to FIGS. 39 and 41 for a cross-sectional view of Embodiment 1 of the present invention, the height of alignment control electrode of the pixel electrode is increased to get closer to the common electrode of the substrate as much as possible.

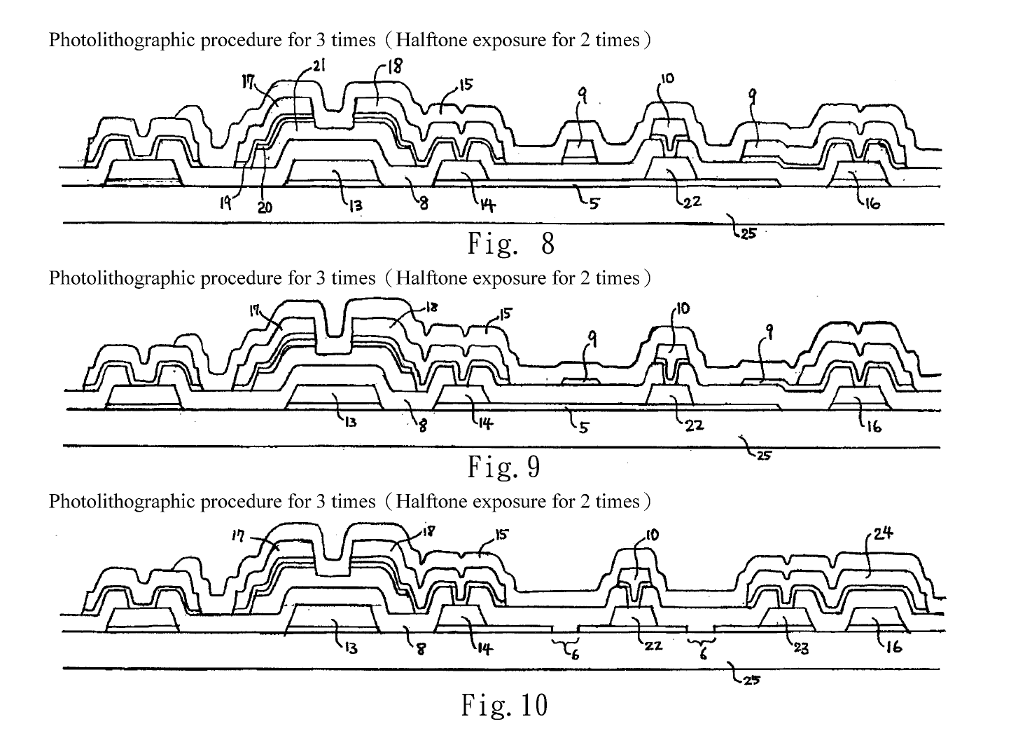

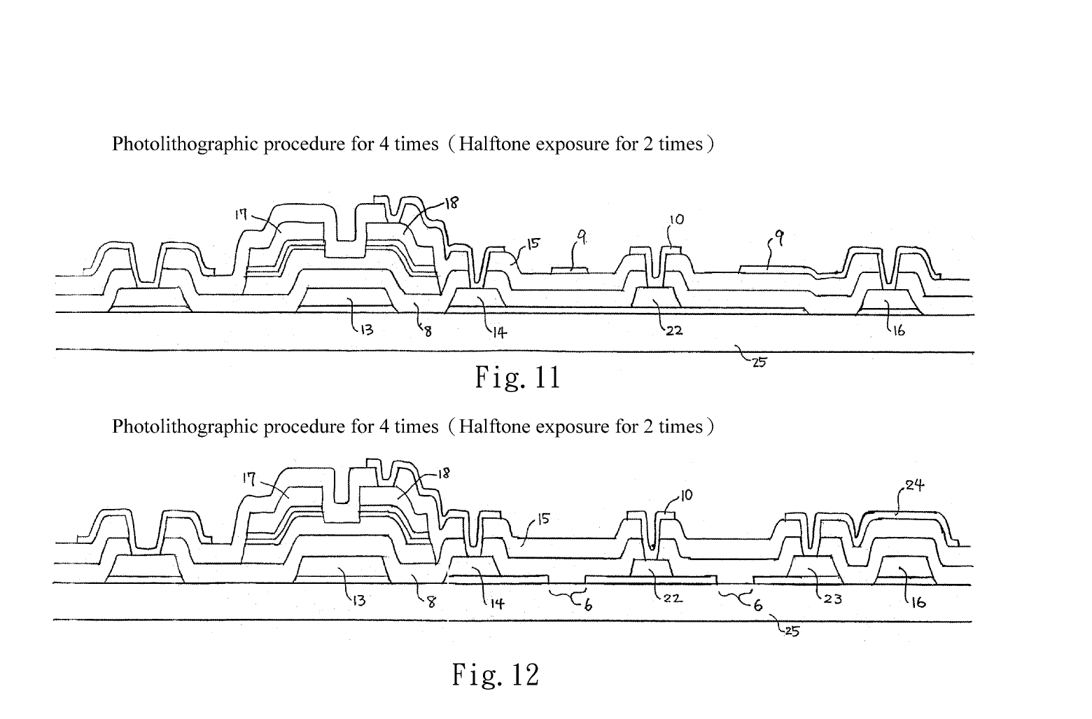

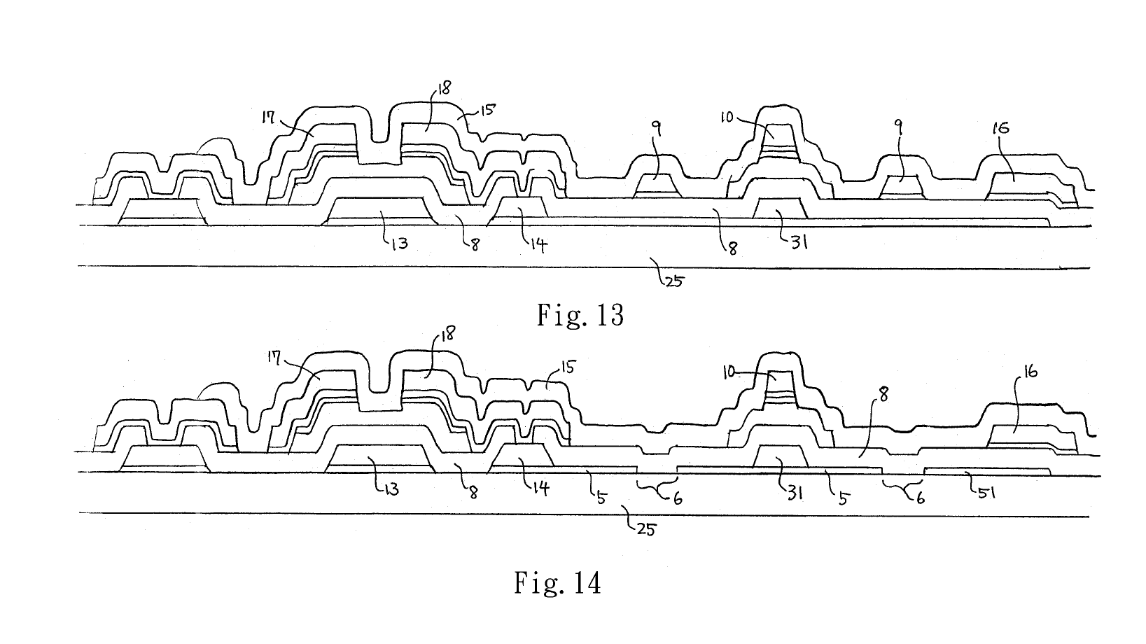

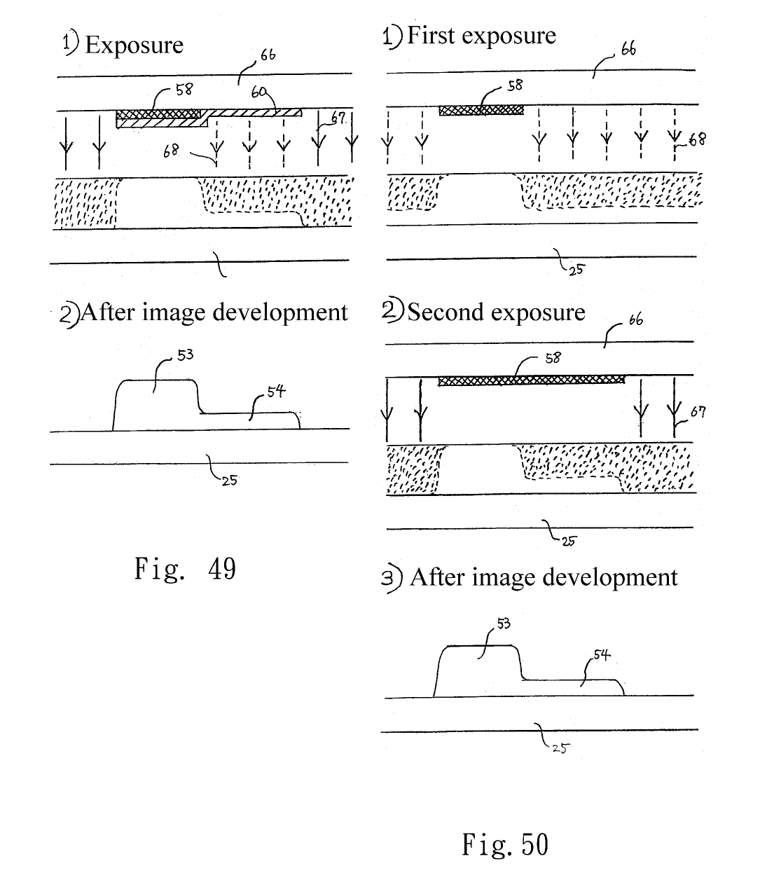

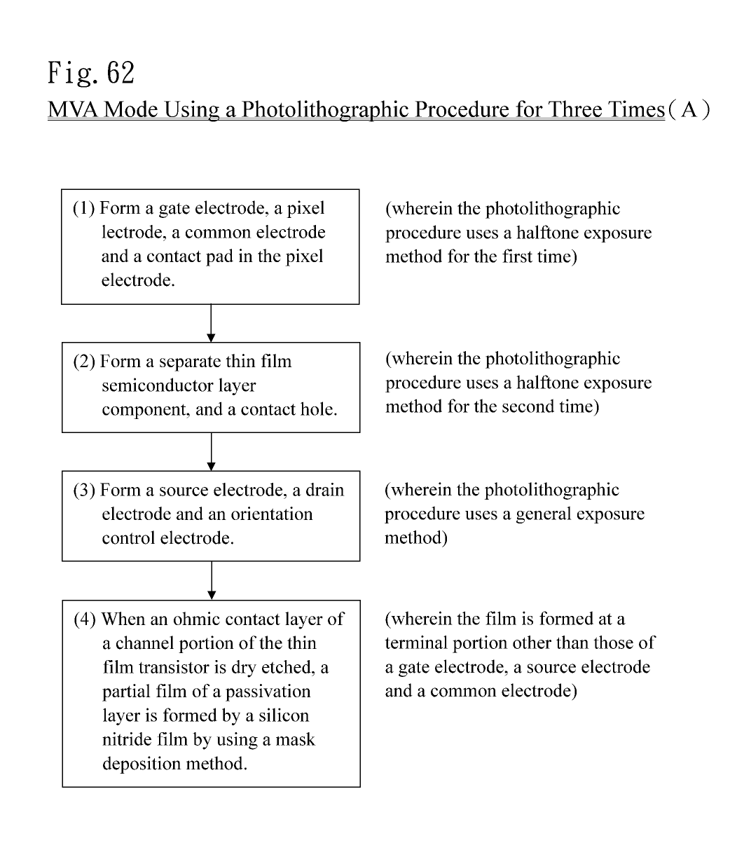

Referring to FIGS. 8, 9, 11, 13, 15 and 17, wherein FIG. 10 is a cross-sectional view of a MVA LCD panel adopting a TFT matrix substrate, FIG. 9 is a cross-sectional view of TFT array substrate used for a MVA LCD panel, and FIGS. 11 and 13, which are the partial cross-sectional views of the TFT array substrate used in the MVA LCD panel shown in FIGS. 15 and 17 respectively, in which the pixel electrode must be installed at a lower layer to form a liquid crystal alignment control electrode at an upper layer of the pixel electrode in accordance with the present invention, and thus its characteristic resides on that the photolithographic procedure is used for producing a pixel electrode. FIG. 8 shows a process of using the photolithographic procedure for three times as depicted in FIG. 62. To shorten the manufacturing process, the present invention adopts a halftone exposure method, characterized in that an exposure method as shown in FIGS. 49 and 50 is used for producing two or more types of posiresist thicknesses after the image is developed.

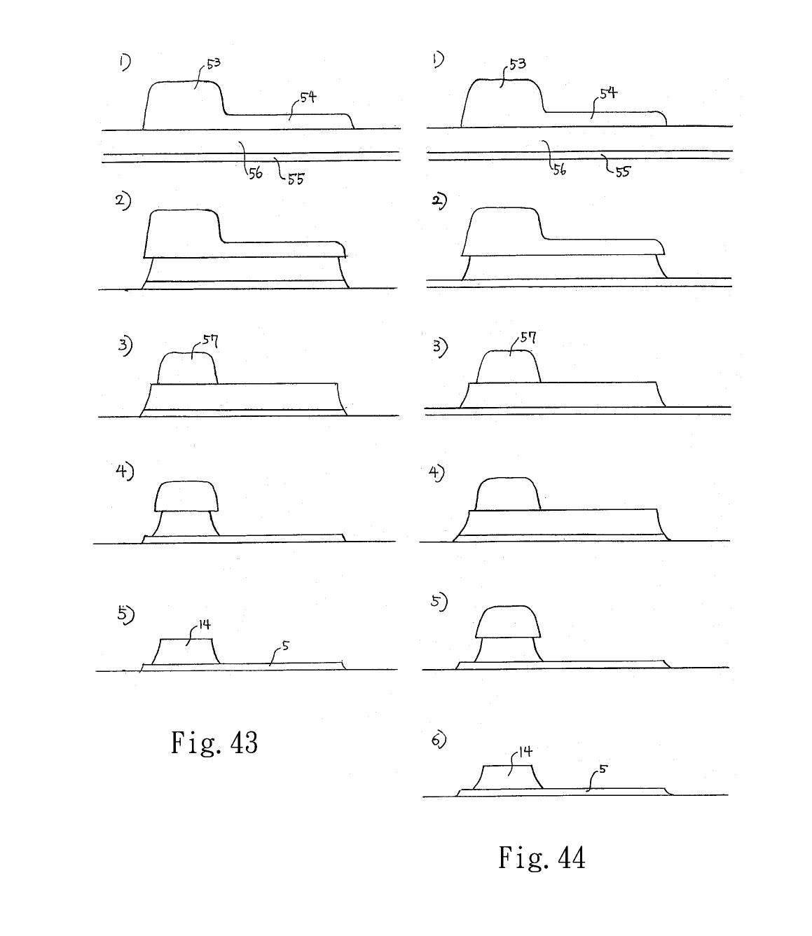

In the first of the three times of photolithographic procedure as shown in FIG. 62, a gate electrode, a pixel electrode, a common electrode and a contact pad in a pixel electrode are formed. In the first procedure, two manufacturing processes exist as shown in FIGS. 43 and 44, and either one of the two manufacturing processes can be used for forming the pixel electrode, but it is preferable to select a shorter process as shown in FIG. 43. If the thickness of the alignment control electrode as shown in FIG. 9 is reduced, and the halftone exposure method is used in the third time photolithographic procedure, it is preferable to select the process as shown in FIG. 44.

Since aluminum alloy is used for making a scan line (or a gate electrode) in this invention, therefore ITO cannot be used in the pixel electrode, because a partial battery reaction will result, and the abnormal corrosion or ITO blackening issues usually occur. As a result, the pixel electrode is generally a transparent electrode made of a thin film oxide such as titanium nitride or zirconium nitride.

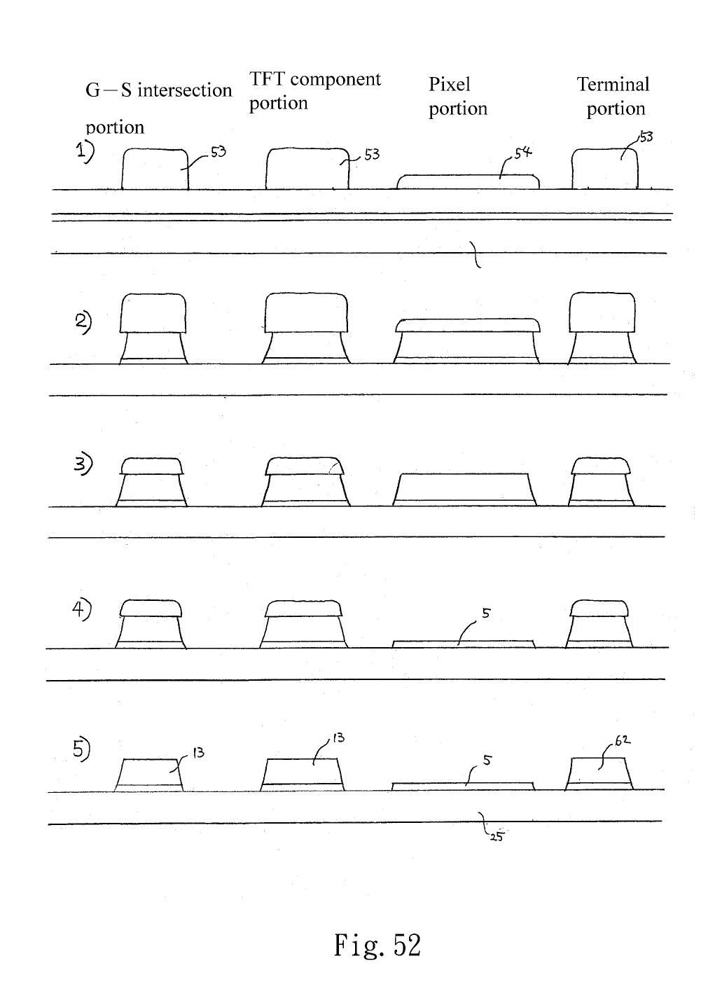

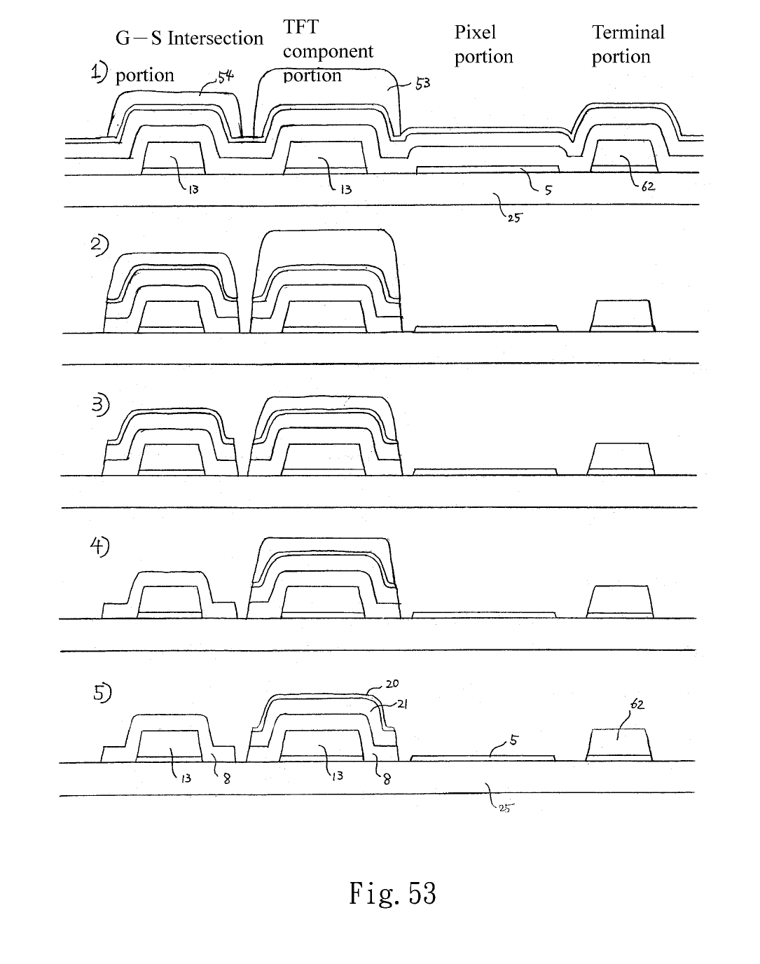

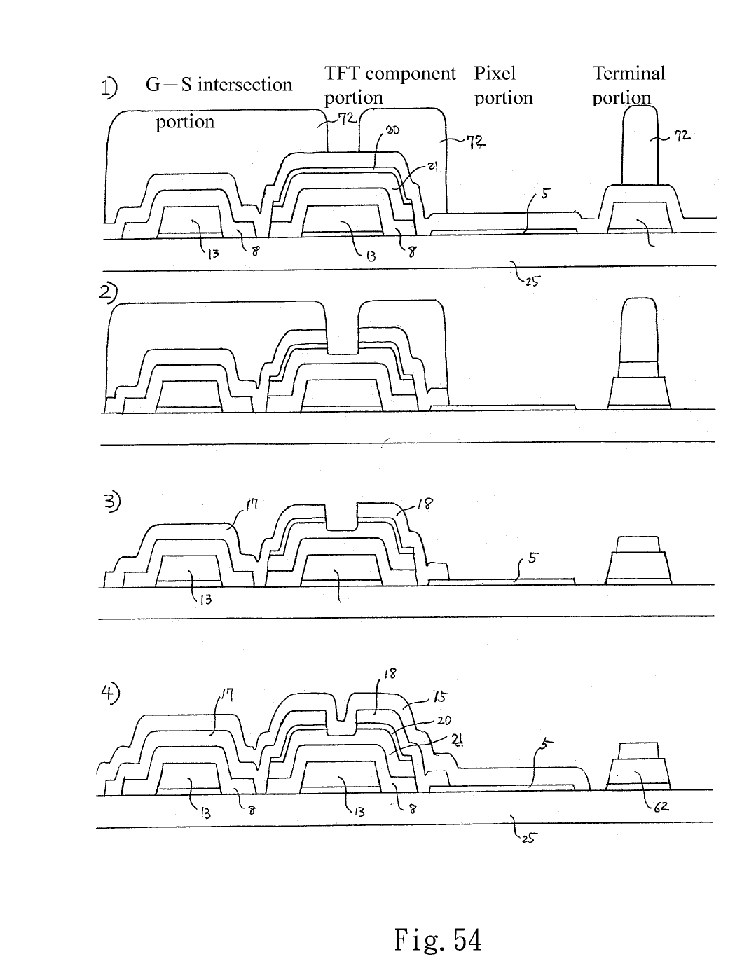

The nitride of the transparent pixel electrode and the P-SiNxo of the gate insulating film cannot have a large selectivity for creating a contact hole by a y etching method, and the manufacturing processes of the previous embodiments as shown in FIGS. 52 to 54 cannot be used anymore. To solve this problem, the present invention uses an aluminum alloy series contact pad to solve the aforementioned problem.

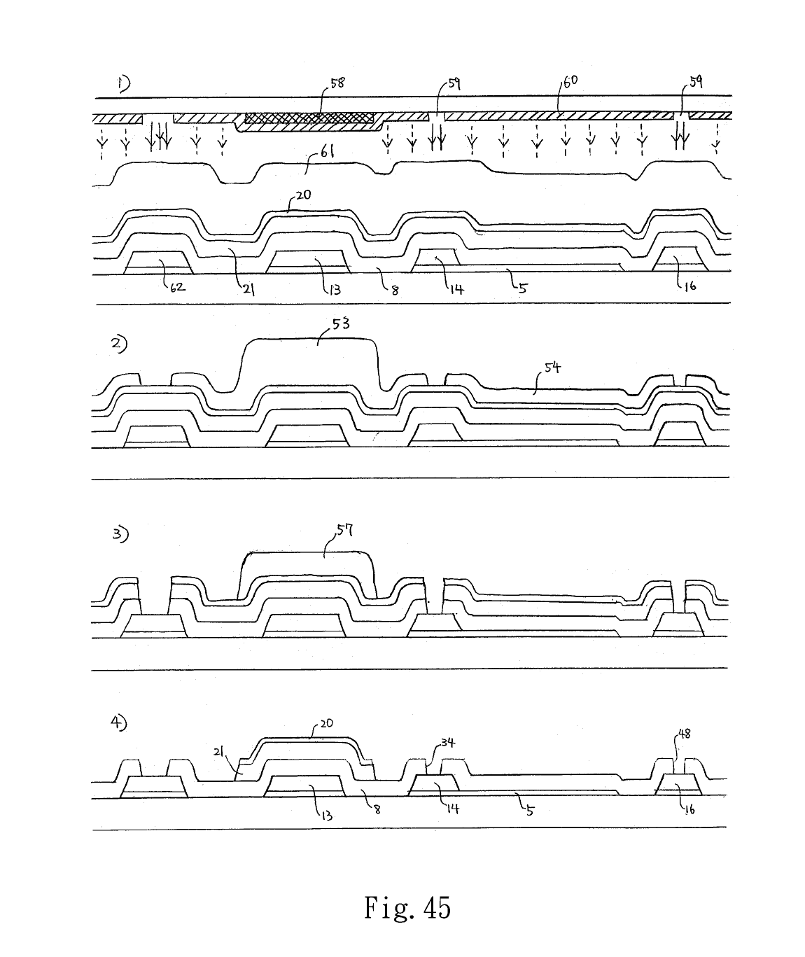

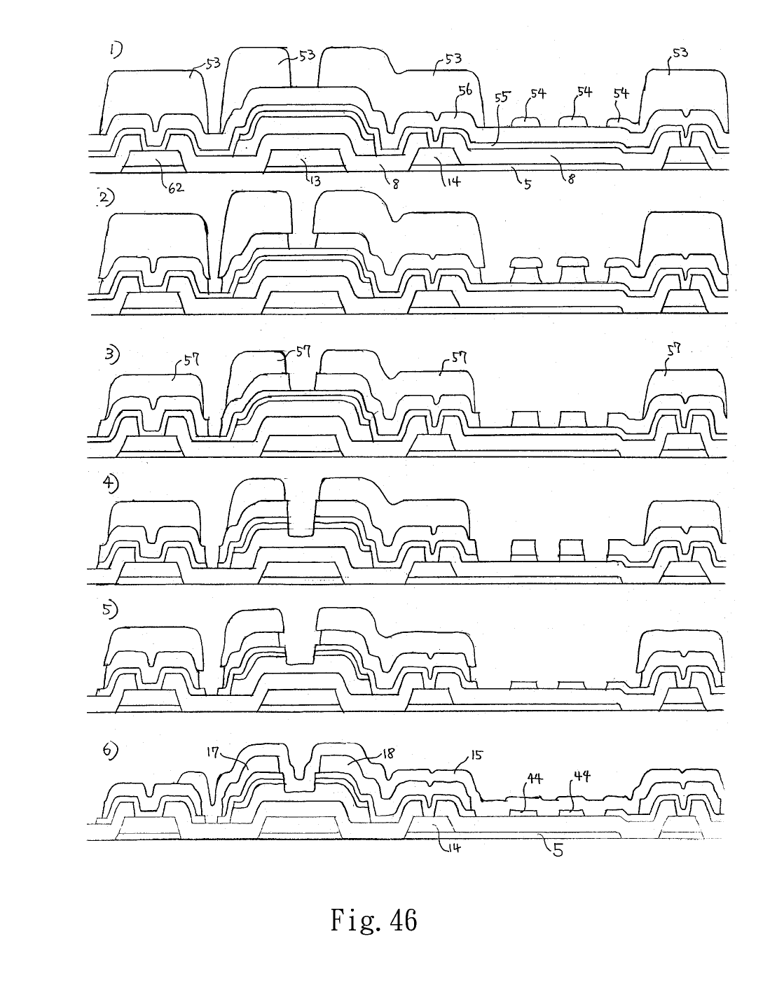

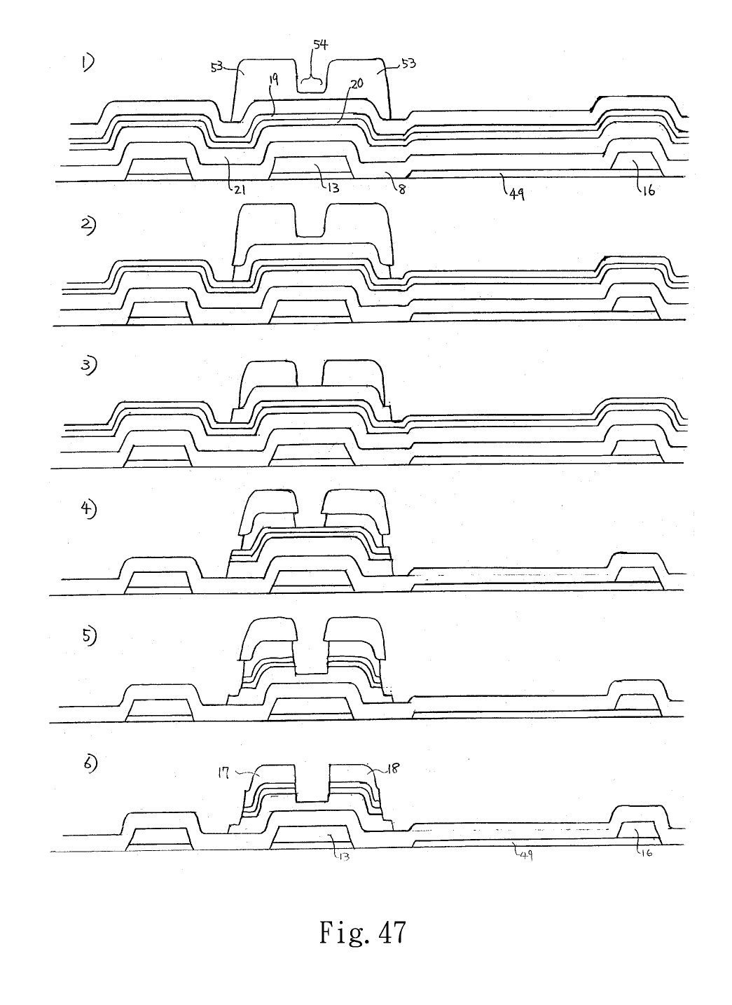

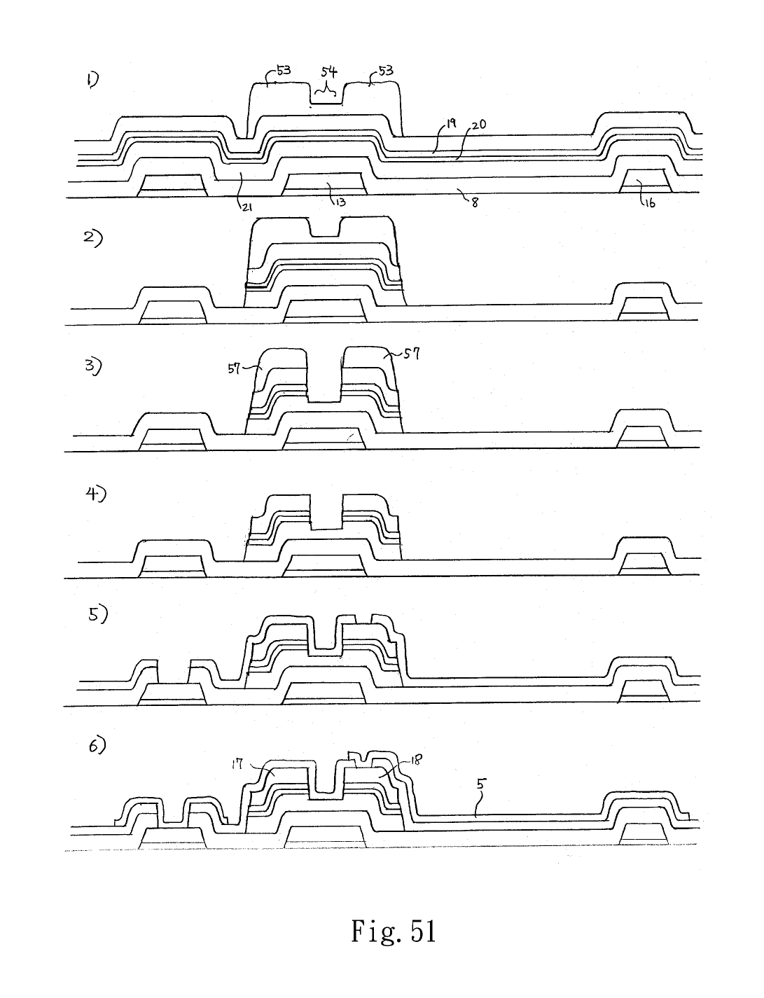

In the second time of the photolithographic procedure, the thin film semiconductor components are separated and the contact hole is formed, and this procedure is illustrated in FIG. 45. Since this procedure also adopts the halftone exposure method, therefore the procedure of the first time can be used for performing two operations. The process adopted in FIGS. 11 and 17 is a halftone exposure process other than that adopted in FIG. 62, and the halftone exposure method as illustrated in FIG. 46 is used for separating the thin film semiconductor components while forming a source electrode and a drain electrode. The halftone exposure process as shown in FIG. 46 is very similar to the halftone exposure process as shown in FIG. 50, but the halftone exposure process as shown in FIG. 47 is more difficult to take place. When a positive photo-resist layer at a thin area is removed by an oxygen plasma method in the foregoing embodiment as shown in FIG. 51, sidewalls of a thin film semiconductor layer are oxidized, and the oxidization takes place easily at the time of removing an ohmic contact layer (n+a—silicon layer) of a channel portion of the thin film transistor component, but an even removal cannot be achieved. In the situation as shown in FIG. 47, the thin film semiconductor layer is protected by a metal barrier layer completely when the positive photo-resist layer at the thin area is removed by the oxygen plasma method, and thus the oxidization almost will not take place at the sidewalls.

In the third photolithographic procedure as shown in FIG. 62, an exposure method is generally used for forming a source electrode, a drain electrode and an alignment control electrode as shown in FIG. 8. In FIG. 9, the third photolithographic procedure also adopts a photolithographic procedure that uses a halftone exposure method as shown in FIG. 46.

In FIGS. 8, 9 and 13, the third photolithographic procedure is used for forming two different types of alignment control electrodes at an upper layer of the pixel electrode through the insulating film. In FIG. 11, a fourth photolithographic procedure is used for forming two different types of alignment control electrodes, such that an oblique direction of vertical alignment negative dielectric constant anisotropic liquid crystal molecules as shown in FIGS. 3 and 5.

In FIGS. 8, 9 and 13, a passivation film is a P-SiNx film formed partially by using a CVD method. An ink-jet printing method or a plate offset printing method is sued to coat a passivation film made of an organic compound such as BCB. The shortcoming of the process shown in FIG. 11 resides on that a short circuit may occur easily at the common electrode of the corresponding substrate when two different types of alignment control electrodes are formed on the passivation film.

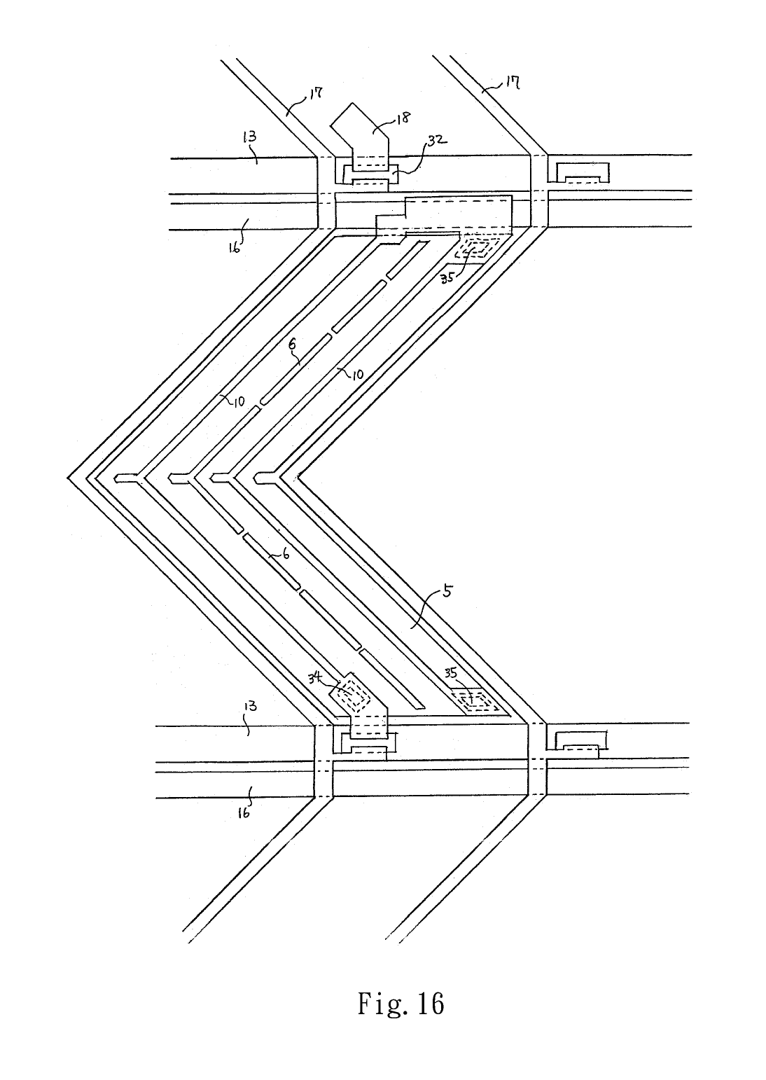

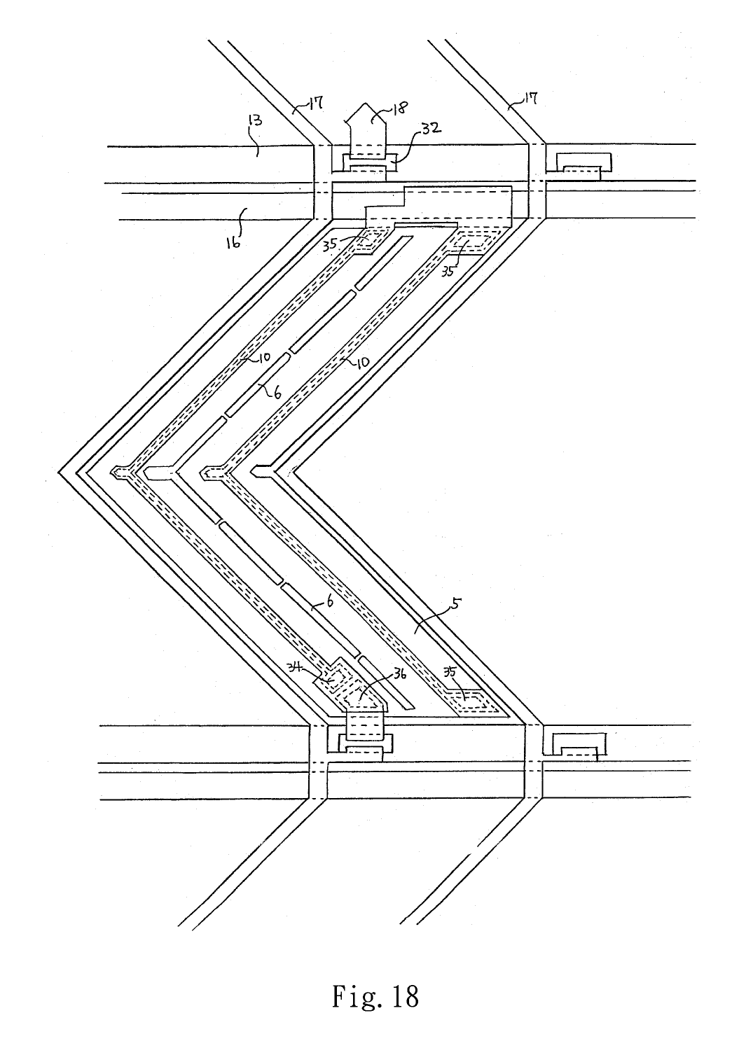

Referring to FIGS. 16 and 18 for planar views of Embodiment 2 of TFT substrate in accordance with the present invention, a slit is formed on the pixel electrode for the alignment control, and a liquid crystal alignment control electrode connected to the pixel electrode is formed at an upper layer of the pixel electrode through the insulating film. Referring to FIGS. 40 and 42 for cross-sectional views of Embodiment 2 of a pixel, Embodiment 2 similar to Embodiment 1 also installs the alignment control electrode connected to the pixel electrode at a position proximate to the substrate, and thus its characteristic resides on that each type of electrodes and semiconductor layers is installed at a lower layer of the alignment control electrode.

Embodiments 1 and 2 of the present invention include all alignment control functions at the TFT substrate side. Compare the Embodiment 1 with the previous methods as shown in FIGS. 1 and 2, the methods adopted by the present invention as shown in FIGS. 3 and 4 also have the existing short-circuit problem at the same layer of a video signal line while the alignment control electrode is being formed. Therefore, the pixel structures as shown in FIGS. 15 and 17 are avoided, and a structure having a curvature of 90 degrees at the center of the pixel is used instead. The video signal line and the alignment control electrode of this structure are arranged in parallel and equidistantly with each other, so as to reduce the chance of having a short circuit.

Referring to FIGS. 10, 12, 14, 16 and 18, wherein FIG. 10 a cross-sectional view of a TFT array substrate used for a MVA LCD panel, and FIGS. 12 and 14 that are partial cross-sectional views of the TFT portions shown in FIGS. 16 and 18 respectively, the basic principle of the Embodiment 2 as illustrated in FIGS. 5 and 6 adopts an alignment control slit for determining the oblique direction of the liquid crystal molecules correctly, but Embodiment 1 cannot increase the strength of electric field as Embodiment 1 does. Therefore, the response rate of Embodiment 2 is slower than that of Embodiment 1. In the application of displaying animations, it is appropriate to adopt Embodiment 1 for the manufacture of LCD panels. From the planar views as shown in FIGS. 15 and 17, many metal wires are installed densely on the same layer in Embodiment 1, and thus the existing short circuit problem may occur easily. In addition to the short-circuit issue, the voltage applied to the pixel electrode of Embodiments 1 and 2 is not 100% applied to the liquid crystal layer, and thus the shortcoming of requiring a higher driving voltage as shown in FIGS. 1 and 2 still exists. Since the CF substrate can use a low-cost CF substrate which has about the same cost of TN, therefore the product competitiveness can be improved. Particularly, it is not necessary to use a field order driven LCD panel of the CF substrate, which must align the upper and lower substrates as shown in FIGS. 1 and 2, but the present invention does not need any manufacture on the substrate as shown in FIGS. 3 and 4. Such arrangement simply needs to form a substrate with a transparent electrode film, and requires no adjustment of alignment theoretically.

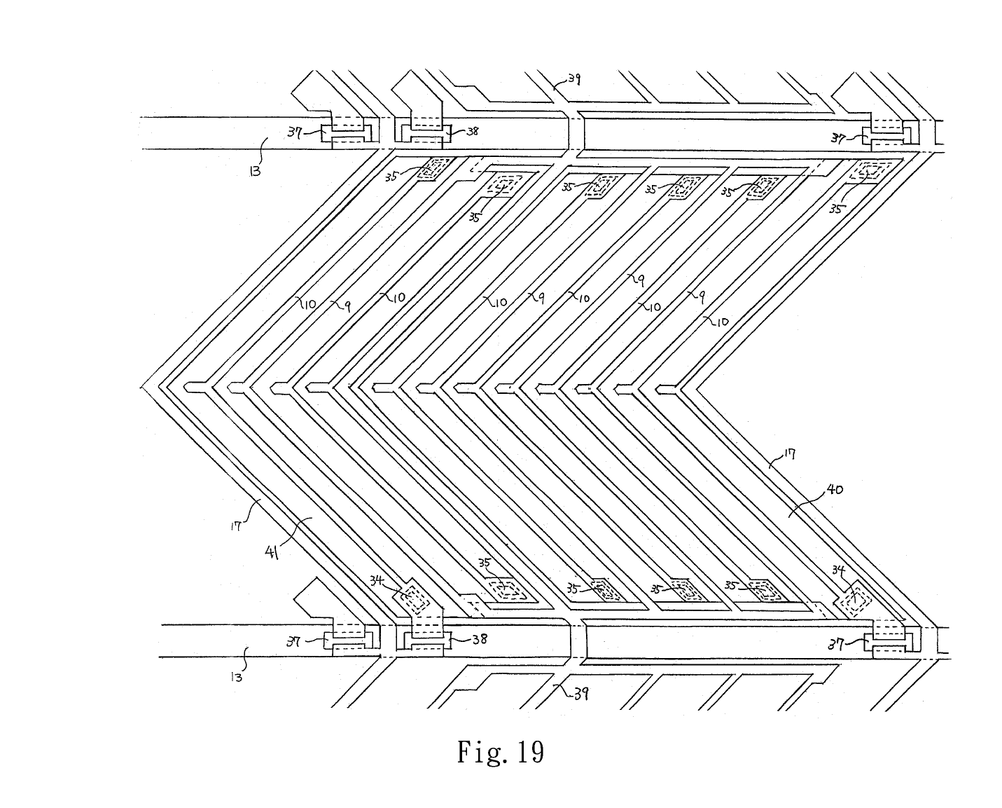

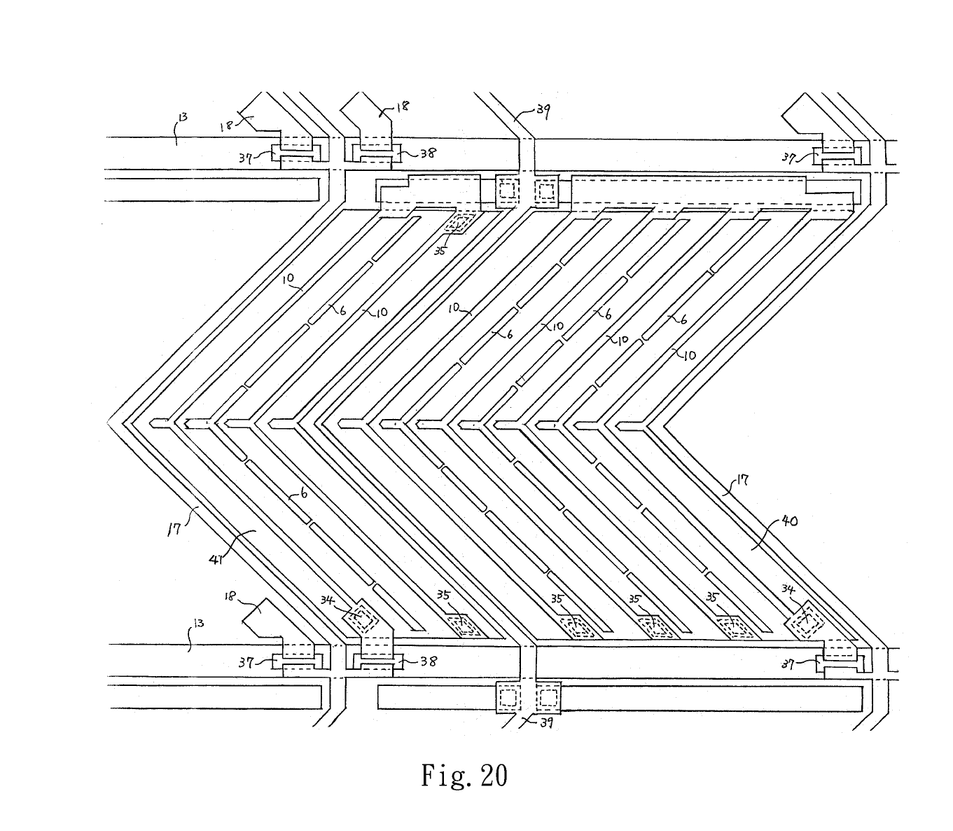

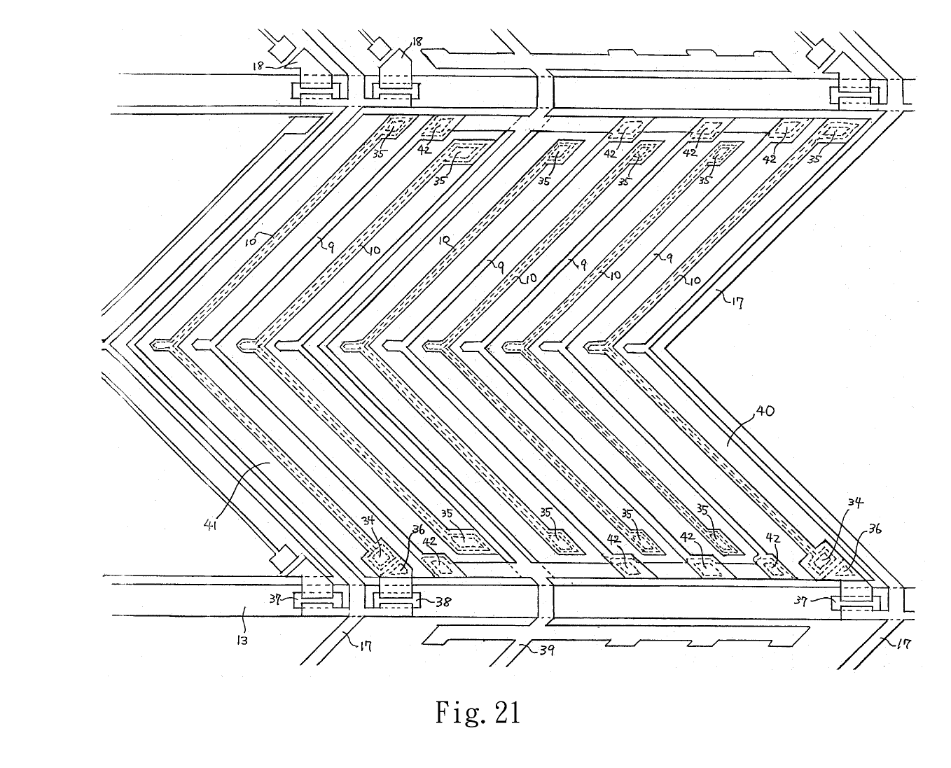

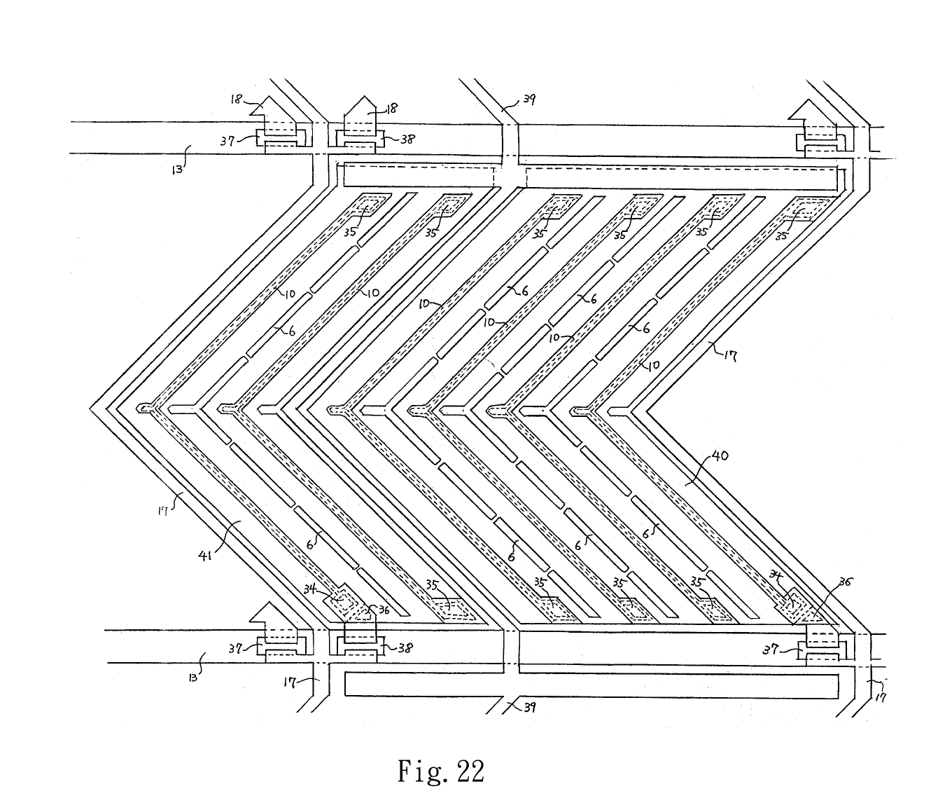

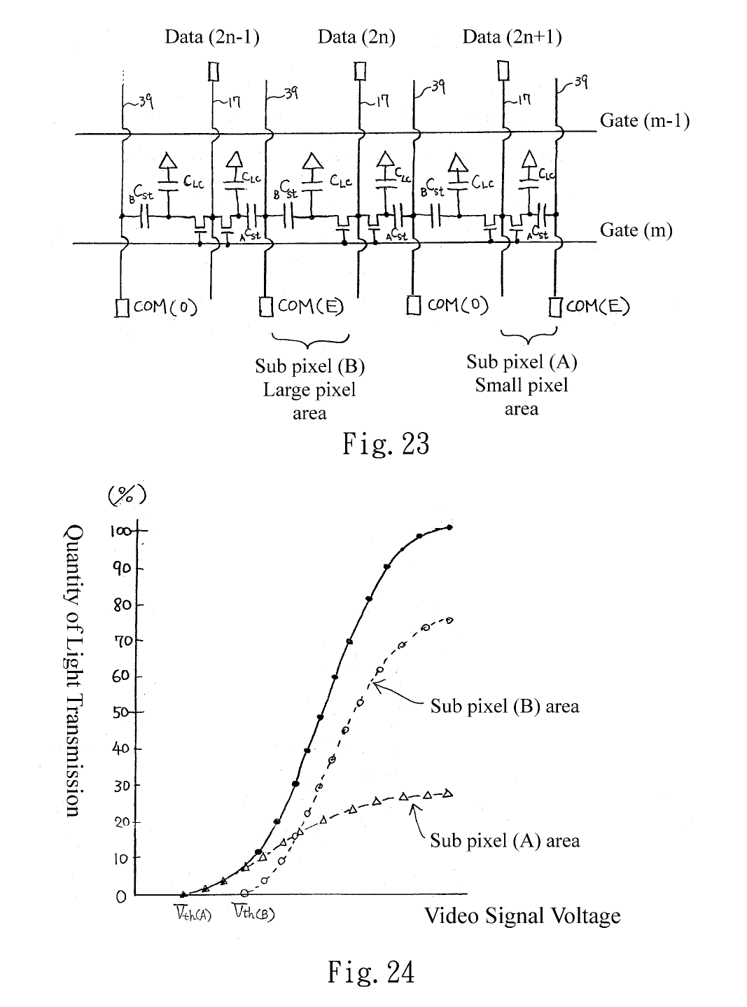

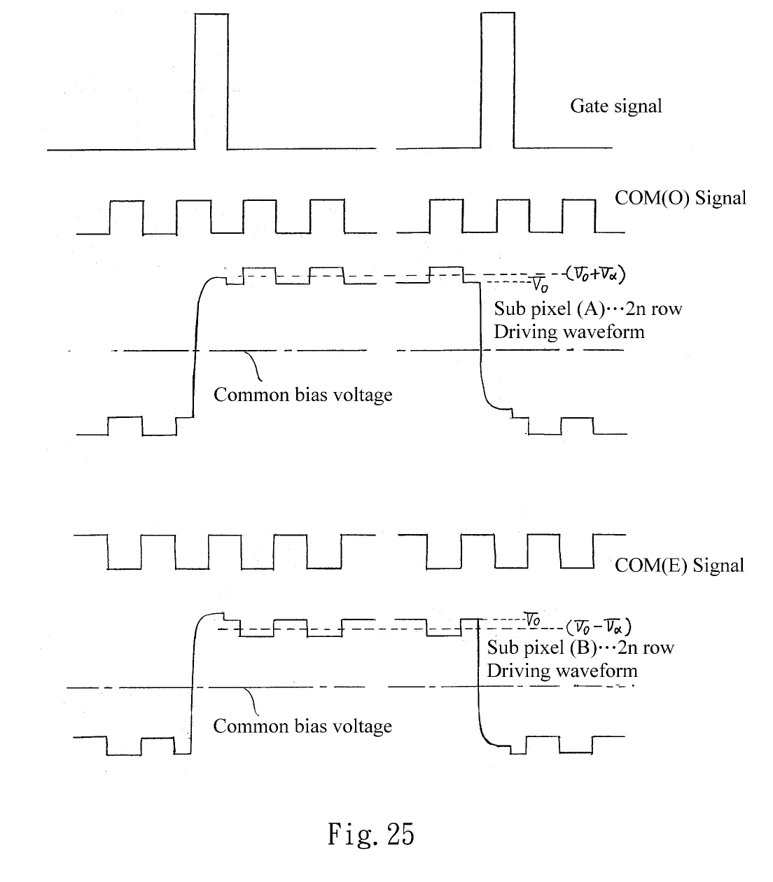

Referring to FIGS. 19 to 22 for planar views of the TFT substrate in accordance with Embodiment 3 of the present invention and FIG. 23 for a circuit model of the TFT substrate of the invention, a basic unit pixel is divided by the video signal line into two sub pixels: sub pixel A and sub pixel B. The ratio of areas of the sub pixel A to the sub pixel B is approximately equal to 1:2. FIG. 25 shows a driving signal waveform of an LCD panel in accordance with Embodiment 3 of the present invention. Even though the data is obtained from the same video signal line, the phase is changed by different common electrode as shown in FIG. 25, since each pixel electrode is combined with a capacitor of a different common electrode, and a horizontal period (H period) is applied, and the waveform of a signal with an opposite polarity maintains the effective voltage of the sub pixel A greater than the effective voltage of the sub pixel B. FIG. 24 shows the quantity of light transmission of the LCD panel when the signal waveform is driven, and the threshold voltage of the liquid crystals of the sub pixel A and the sub pixel B can be changed for correcting y.

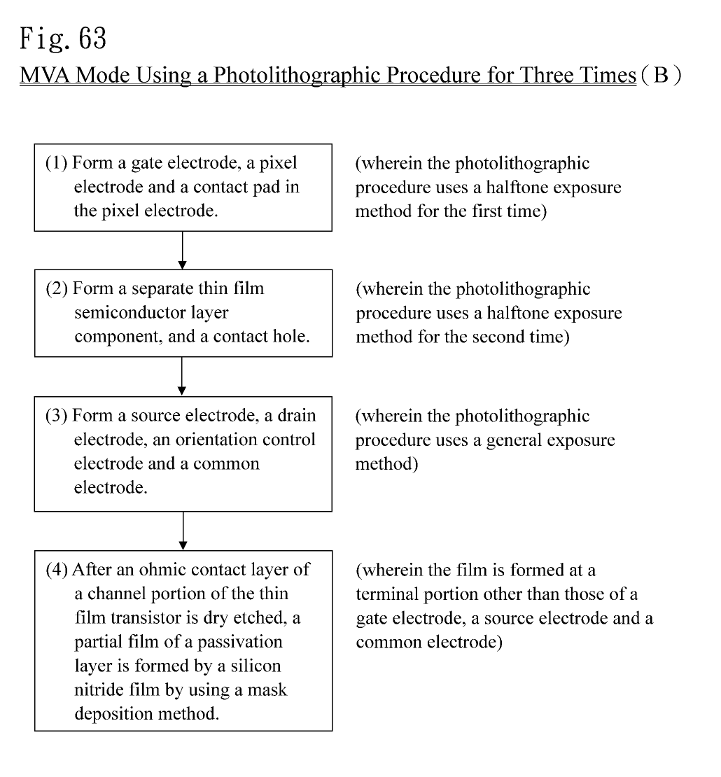

FIG. 63 shows the process of manufacturing the TFT substrates as illustrated in FIGS. 19 to 22, and FIG. 62 illustrates Embodiment 1. A common electrode is manufactured in the first the photolithographic procedure. In Embodiment 3 as shown in FIG. 23, it is not necessary to arrange the video signal line in parallel with the common electrode, and thus the common electrode is manufactured by the third photolithographic procedure as shown in FIG. 63.

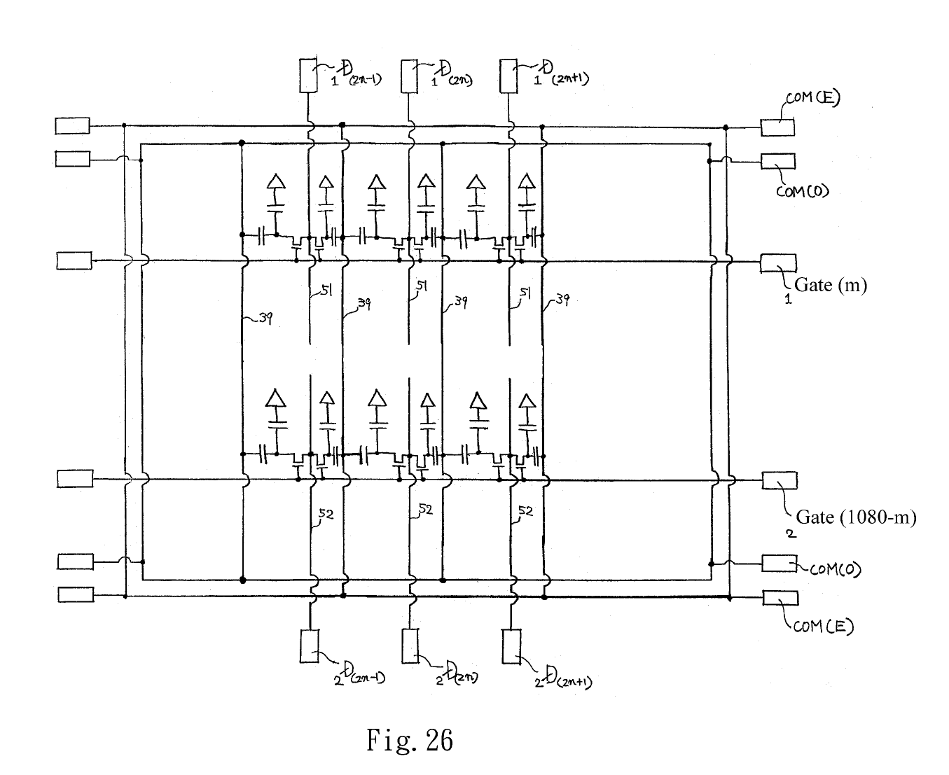

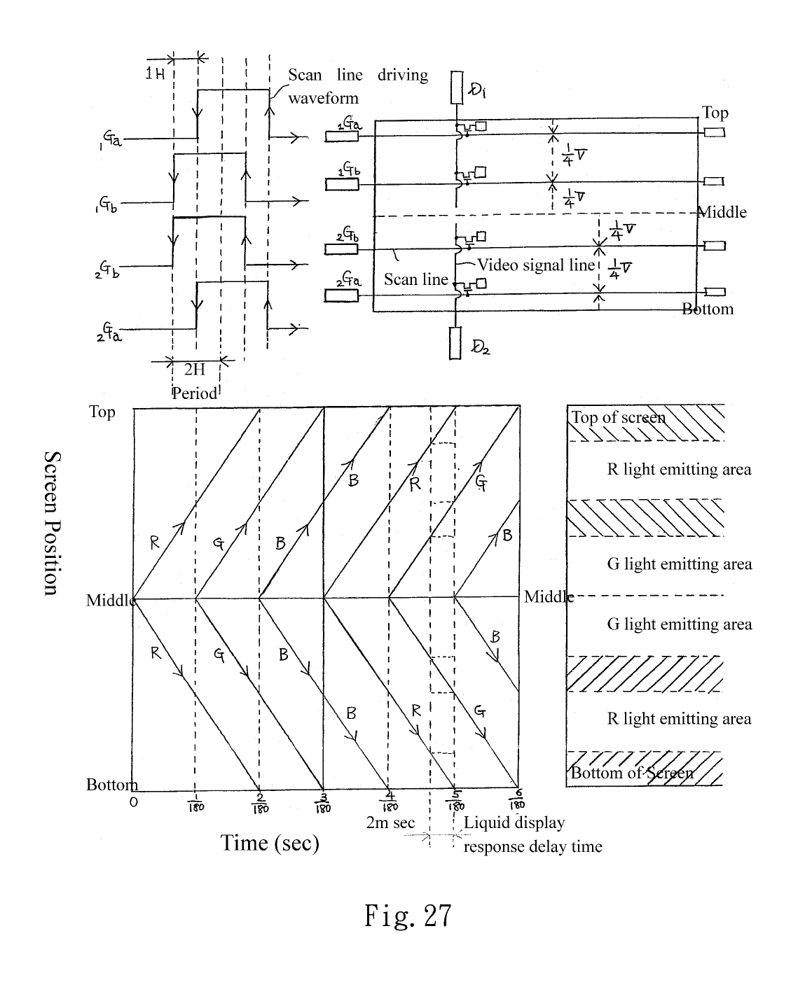

FIG. 26 shows a circuit model of the TFT substrate when a high-precision super large LCD panel is manufactured. FIGS. 27 to 30 show the method of driving a TFT substrate as illustrated in FIG. 26, FIGS. 27 to 30 relate to the field order driving method. Since the display screen is divided into two: an upper screen and a lower screen, therefore the video signal line is also divided into two: an upper video signal line and a lower video signal line, and the video signals of the same polarity are applied.

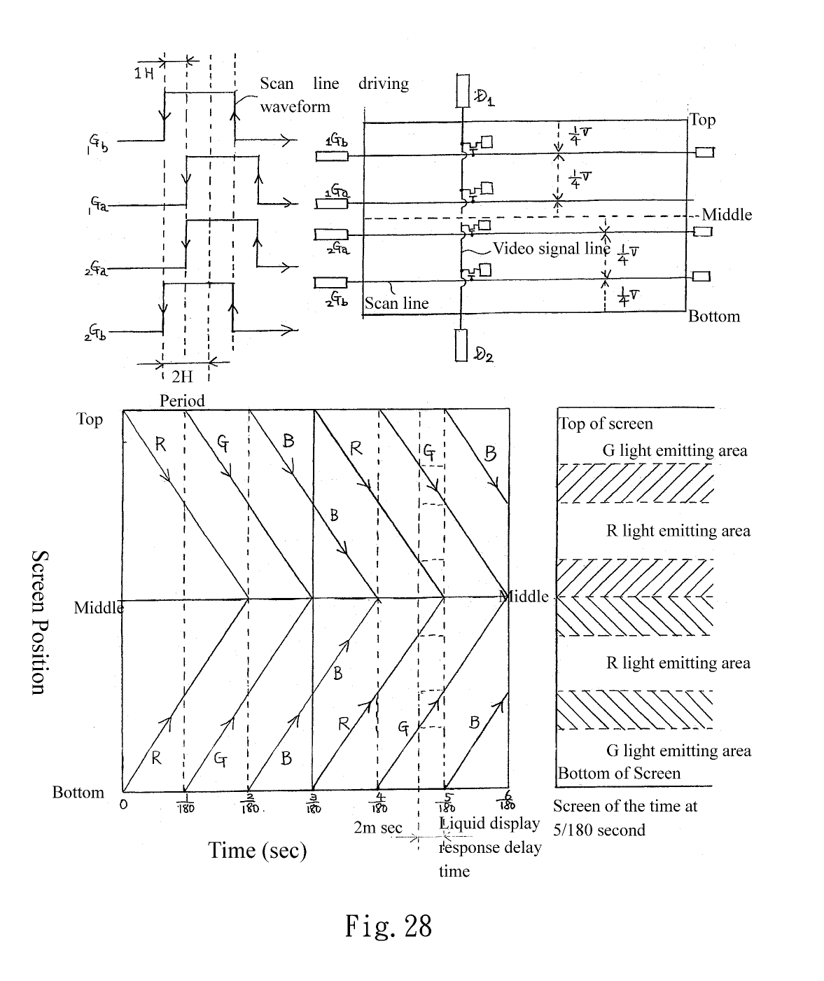

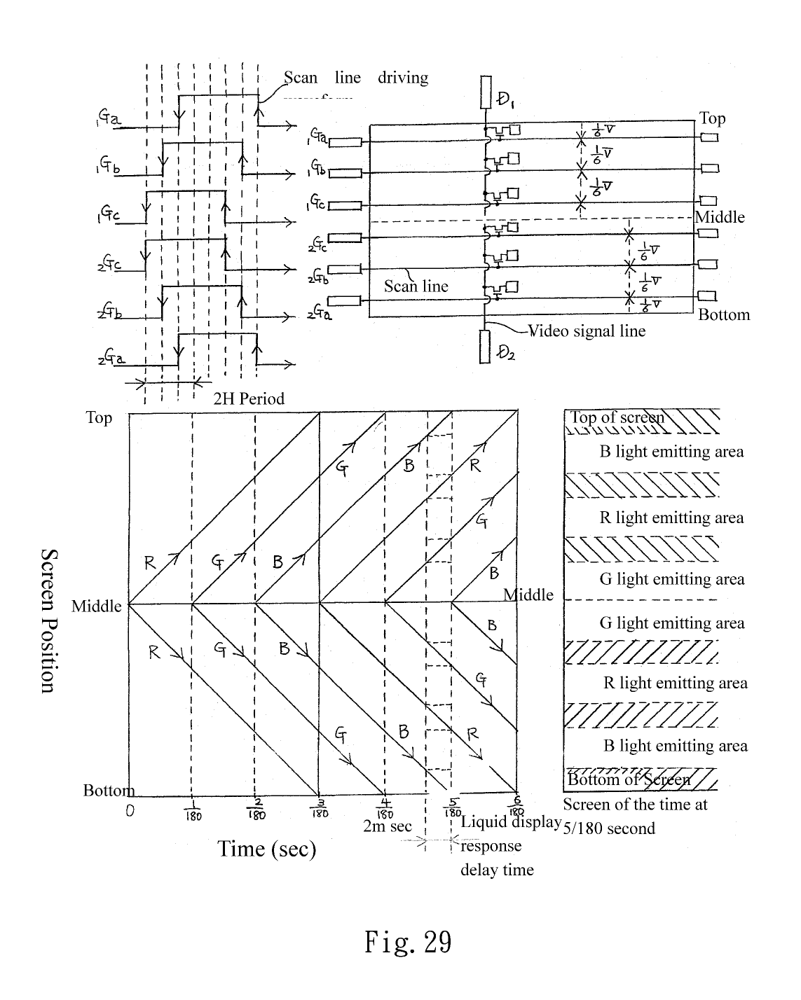

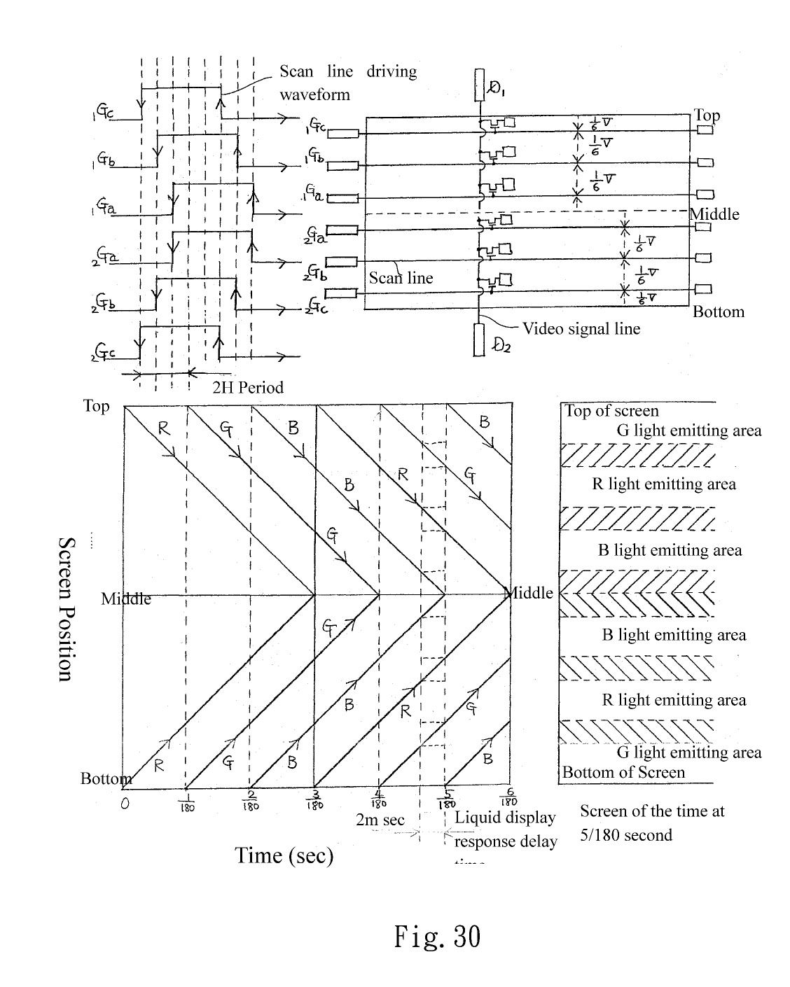

The common electrode has not been divided into two, but both upper and lower portions integrated. FIGS. 27 and 29 show that video signals are written from the center of the screen to the upper and lower screens in order to prevent the blocks of the upper and lower screens from being separated. FIGS. 28 and 30 show that the video signals are written from the upper and lower screens to the center of the screen. To divide the display screen into two, the horizontal scan period is extended to two times of 2H. FIGS. 27 and 28 show that the horizontal scan period is divided into two, such that different video signals can be written for two pixels by two different multitasking methods. FIGS. 29 and 30 show that the horizontal scan period is divided into three, such that different video signals can be written for three pixels by three multitasking methods.

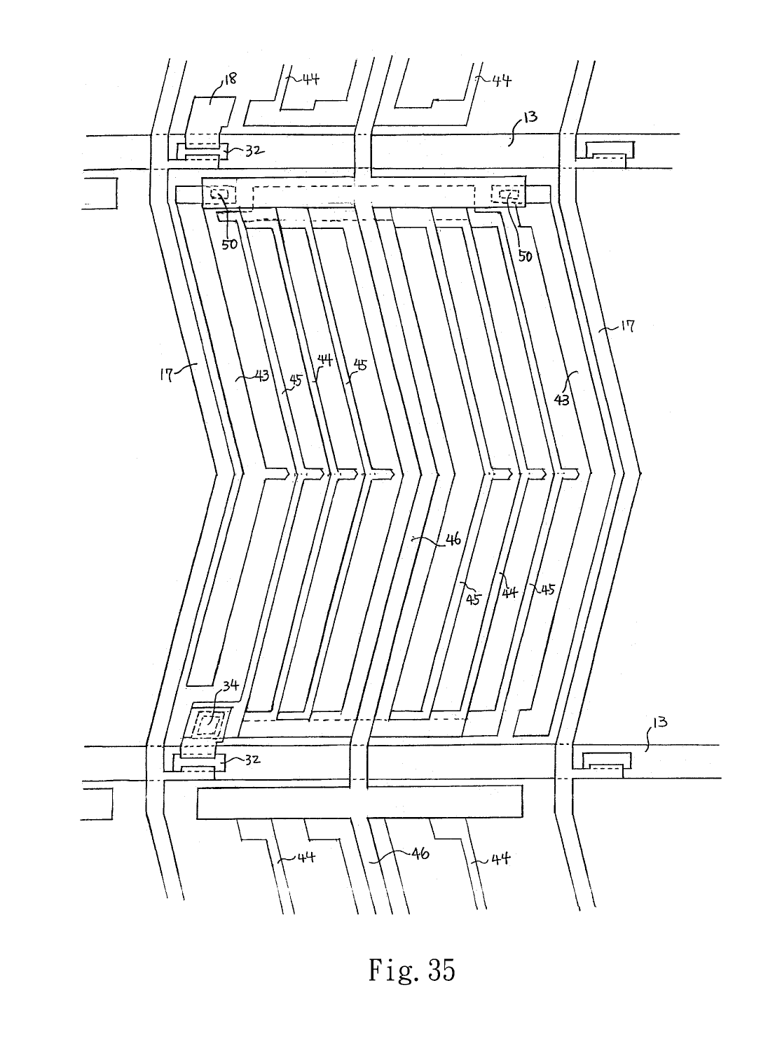

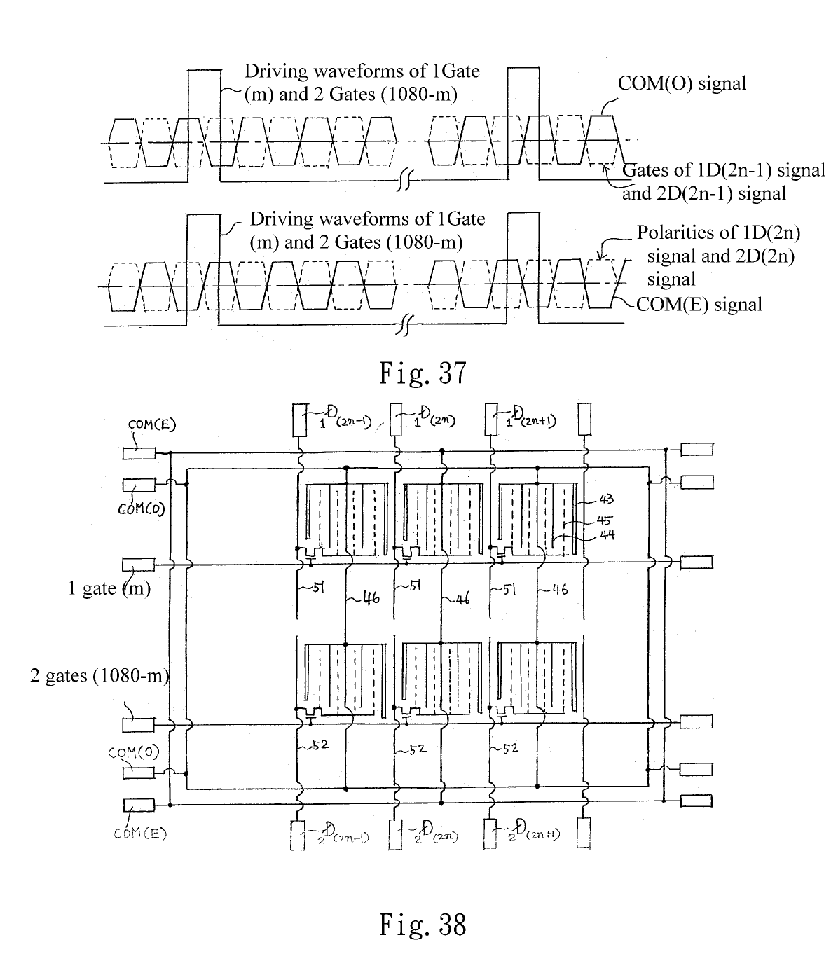

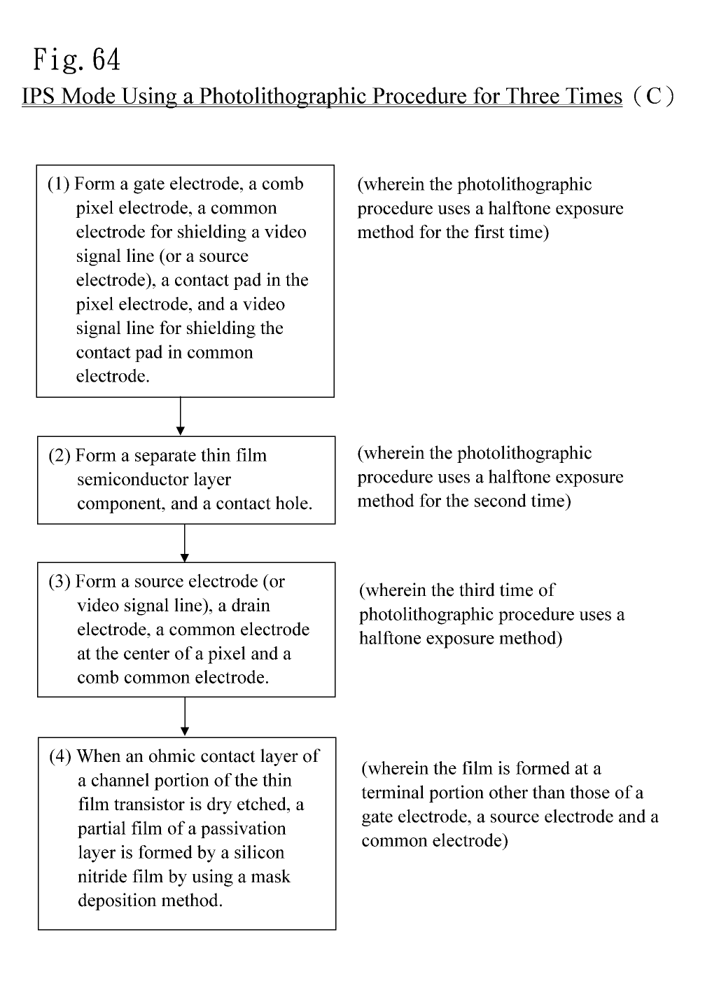

Referring to FIGS. 35 and 32 for a planar view and a cross-sectional view of an IPS TFT substrate in accordance with Embodiment 4 of the present invention, and FIG. 64 for the manufacturing process of an IPS TFT substrate in accordance with Embodiment 4 of the present invention, three times of photolithographic procedure adopting three times of halftone exposure method are conducted. FIG. 33 shows a circuit model of a TFT substrate as illustrated in FIG. 35. The center of a pixel and the video signal are arranged in parallel with the common electrode. FIG. 38 shows a circuit model of a TFT substrate when a high-precision supper large LCD panel is manufactured. FIG. 37 shows a driving waveform diagram of a TFT substrate as illustrated in FIG. 38. Signal waveforms of different polarities are applied on even-numbered rows and odd-numbered rows, and signal waveforms of different polarities are applied to the even-numbered rows and odd-numbered row of video signal waveforms, and a signal with an opposite polarity is applied to the common electrode of each corresponding video signal line.

Even the modes of liquid crystals are different, the circuit models of the common electrode and the video signal line is identical to those as shown in FIG. 26. The IPS TFT substrate as shown in FIG. 38 can also adopt the same field order driving method of Embodiment 3. Similar to the process as shown in FIG. 26, the process as shown in FIG. 38 divides the display screen into two: an upper screen and a lower screen, and thus the video signal line is also divided into two: an upper video signal line and a lower video signal line, and the polarity of video signals are the same.

The common electrode has not been divided into two, but it is connected from top to bottom as a whole. To prevent the blocks of upper and lower screens from being separated, the video signals are written from the center of the screen upward or downward, or the video signals are written from the top or bottom of the screen towards the center of the screen. The driving method for the scan lines is identical to that of Embodiment 3.

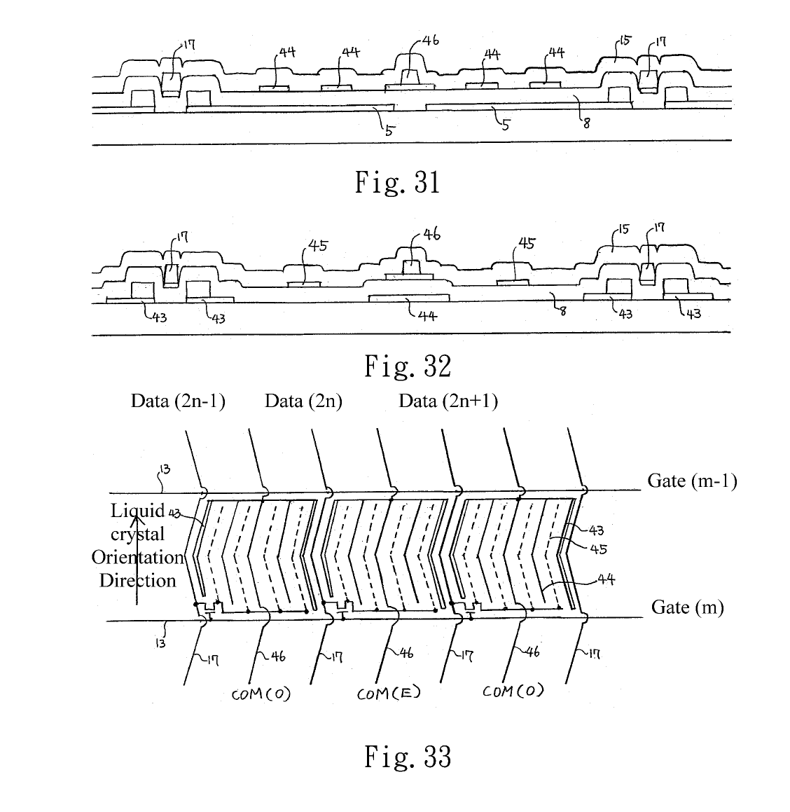

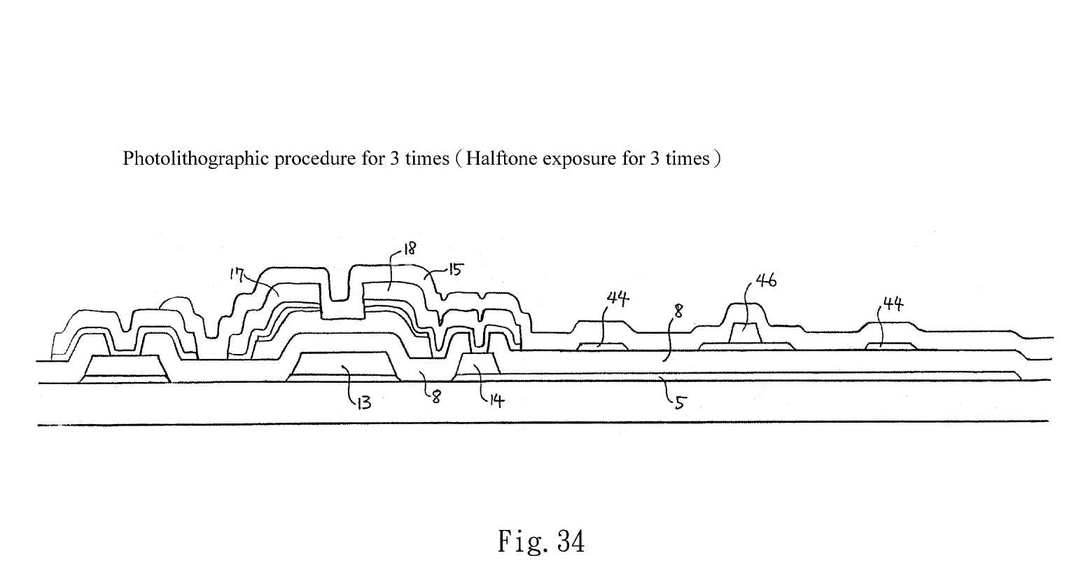

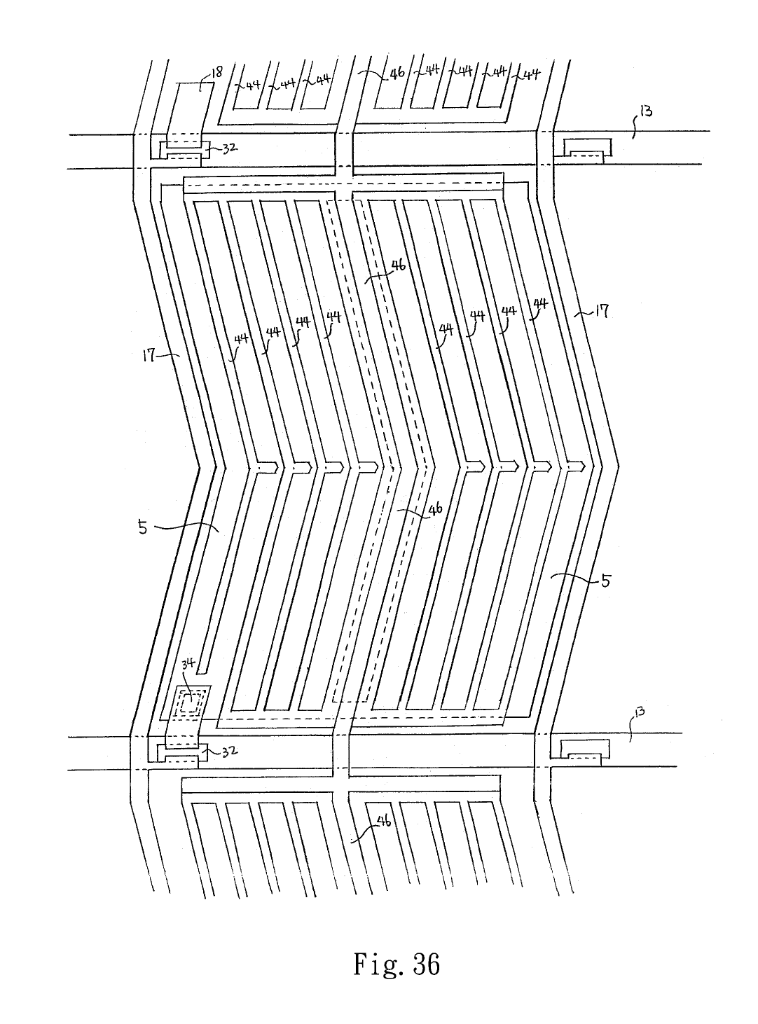

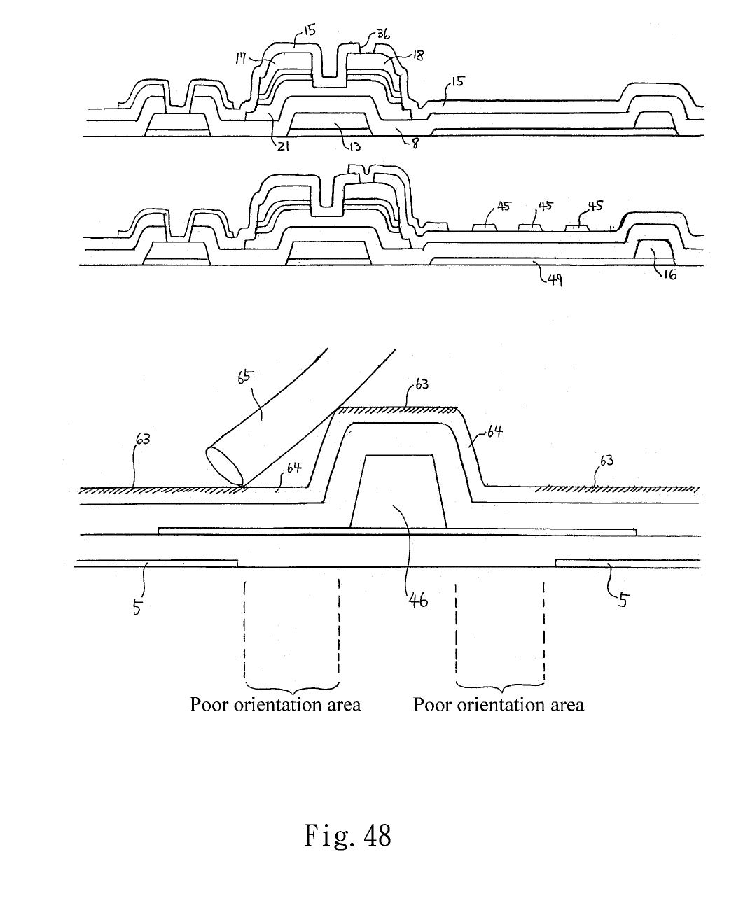

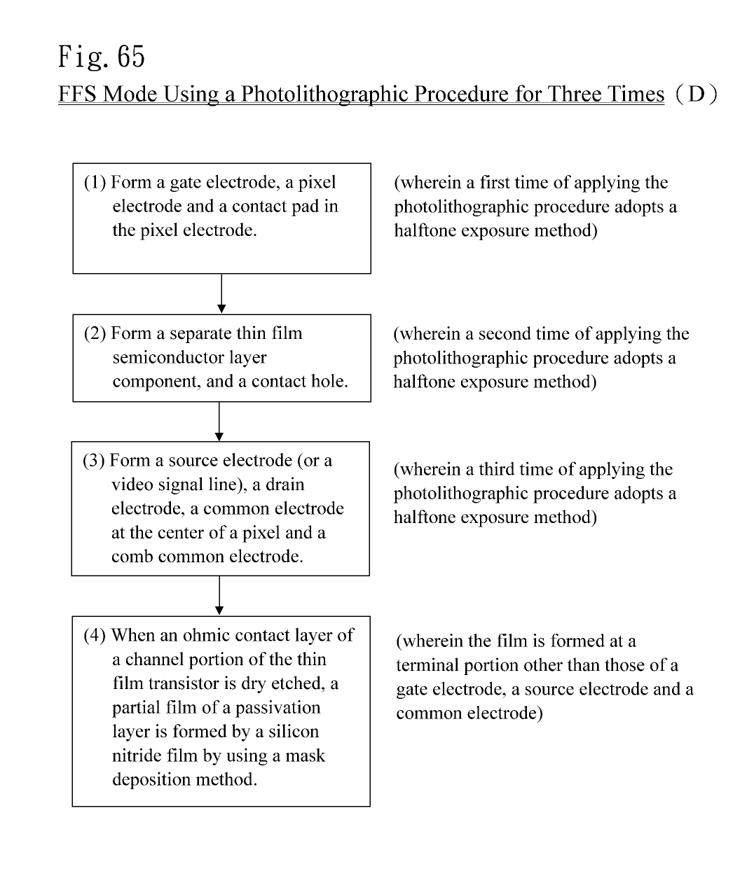

Referring to FIGS. 36 and 31 for a planar view and a cross-sectional view of a FFS TFT substrate in accordance with Embodiment 5 of the present invention respectively, FIG. 34 for a cross-sectional view of a portion of a thin film transistor, and FIG. 65 for the manufacturing process of a FFS TFT substrate in accordance with Embodiment 5 of the present invention, the photolithographic procedure is conducted for three times, and a halftone exposure method is applied for all of the three times. The three times of photolithographic procedure in Embodiments 4 and 5 use the halftone exposure method as shown in FIG. 48. Unlike the vertical alignment LCD panel, a horizontal electric field panel requires different alignment processing procedure (such as the friction processing). To prevent having a poor alignment area, it is necessary to minimize the roughness of the TFT substrate. However, the planar views of FIGS. 35 and 36 show that the thickness of electrodes is increase to lower the resistance of a common electrode at the center of the screen.

Since a poor alignment area as shown in FIG. 48 must occur in both IPS and FFS modes, therefore the shortcoming of unable to show the black color for a black potential exists. To minimize the poor alignment area, it is necessary to apply the halftone exposure method for three times.

FIGS. 43 and 44 use the manufacturing process as illustrated in FIG. 65, the process of the halftone exposure method is applied for one time, and any one can be selected. FIG. 45 illustrates the process of applying the halftone exposure method for the second time, and FIG. 46 illustrates the process of applying the halftone exposure method for three times, and FIG. 47 illustrates the process of performing the photolithographic procedure for four times for manufacturing the FFS TFT substrate. The halftone exposure method is applied for two times.

Even if the FFS TFT substrate as shown in FIG. 36 adopts the same driving method as the IPS TFT substrate as shown in FIG. 35, all circuit models of the TFT substrate as shown in FIG. 38 can be applicable for the FFS mode of FIG. 36. If the driving method of FIG. 37 is used, the FFS mode with a high driving voltage can be driven easily. Since the FFS mode can produce a strong electric field, therefore the response rate of the liquid crystal molecules is smaller than that of the IPS mode and applicable for the field order driving method. Particularly, a high voltage can be applied to the LCD panels as shown in FIGS. 37 and 38, and thus such method is considered as a driving method applicable for high-speed operations, and most suitable for the field order driving method for the divided upper and lower screens as shown in FIGS. 27 to 30.

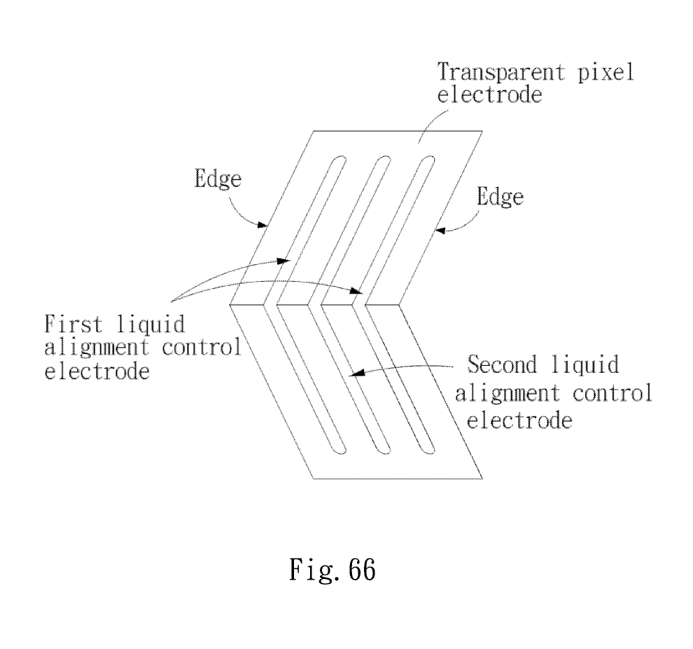

FIG. 66, the transparent pixel electrode of the active matrix vertical alignment liquid crystal display apparatus is formed on the transparent substrate of TFT, wherein the transparent pixel electrode comprises a plurality of edges surrounded the transparent pixel electrode. The edge of the transparent pixel electrode is closer to the first liquid crystal alignment control electrode that is connected to the transparent pixel electrode than the second liquid crystal alignment control electrode that is connected to the common electrode on the TFT substrate.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims.

What is claimed is:

1. An active matrix vertical alignment liquid crystal display apparatus, comprising:
a transparent pixel electrode, formed on a transparent substrate of TFT, wherein the transparent pixel electrode comprises a plurality of edges surrounded the transparent pixel electrode;
a transparent electrode is connected to a drain electrode of TFT;
a transparent insulating film formed on the transparent pixel electrodes; and
a plurality of slender slits, which have liquid crystal alignment control power in the transparent pixel electrode;
wherein the liquid crystal alignment control electrodes are connected to the transparent pixel electrode, and the liquid crystal alignment control electrodes are slender formed on the transparent pixel electrode; and a transparent common electrode is located on an opposite transparent substrate, which is opposite to the transparent TFT substrate, and the transparent TFT substrate is connected to common electrodes formed on the transparent TFT substrate.

2. The active matrix vertical alignment liquid crystal display apparatus of claim 1, wherein the liquid crystal alignment control electrodes and the slender slits are parallel to each other, and the edges of the transparent pixel electrode are closer to the liquid crystal alignment pixel electrode than the slender slits in the transparent pixel electrode.

3. The active matrix vertical alignment liquid crystal display apparatus of claim 1, wherein the apparatus further comprises a video signal line and a scan line, wherein the video signal line, the transparent pixel electrode, the liquid crystal alignment control electrode, the slender slits in the transparent pixel electrode bend 90 degrees once at the center of the transparent pixel electrode, and the edges surrounded the transparent pixel electrode are also bent at 90 degrees in respect to the center of the transparent pixel electrode.

4. The active matrix vertical alignment liquid crystal display apparatus of claim 1, wherein the apparatus further comprises a video signal line and a scan line, the edge of the transparent pixel electrode is closer to the liquid crystal alignment pixel electrode which is connected to the transparent pixel electrode than the slender lists in the transparent pixel electrode, and the video signal line, the transparent pixel electrode, the liquid crystal alignment control electrode, the slender slits in the transparent pixel electrode bend 90 degrees once at the center of the transparent pixel electrode in a pixel, and are aligned to the scan line at approximately 45 degrees.
